(19) United States
(12) Patent Application Publication
(10) Pub. No.: US 2025/0037014 A1
(43) Pub. Date: Jan. 30, 2025

(54) UNIVERSAL AND MACHINE LEARNING MODEL AGNOSTIC CONTROL AND TRACKING

(71) Applicant: Optum, Inc., Minnetonka, MN (US)

(72) Inventors: Cory MUIR, Minneapolis, MN (US); Vivek BHADAURIA, Bothell, WA (US); Anand Dhandhania, Renton, WA (US); Vasant MANOHAR, Apex, NC (US)

(21) Appl. No.: 18/358,302

(22) Filed: Jul. 25, 2023

(51) Int. Cl. G06N 20/00

(52) U.S. Cl. CPC G06N 20/00

(57) ABSTRACT

Various embodiments of the present disclosure provide universal machine learning tracking and control techniques for enforcing universal standards across a plurality of disparate machine learning projects within an enterprise. The techniques include generating a canonical representation of a machine learning model. The techniques include receiving model activity data from a third party computing resource in response to user activity within a third party workspace. The techniques include generating relative progress data for the machine learning model based on the model activity data and modifying the canonical representation of the machine learning model based on the model activity data and the relative progress data. The techniques include generating and providing a model interface point for the machine learning model in response to the canonical representation satisfying a publication threshold.

### BACKGROUND

Various embodiments of the present disclosure address technical challenges related to the development, deployment, and management of machine learning models given limitations of existing machine learning project workspaces hosted by specific computing platforms. Conventional machine learning workspaces are hosted within one of many available computing environments that are each specifically tailored to a different stage of model development and maintenance. For instance, a first workspace hosted by a first cloud provider, such as Azure Blob Storage and/or the like, may include functionalities tailored to processing datasets for training, evaluating, and validating a model, whereas a second workspace hosted by a second cloud provider, such as AWS's Sagemaker Canvas and/or the like, may include functionalities tailored to the actual configuration, training, and validation of the model. Creating a machine learning project by convention means therefore may require the use of multiple disparate and traditionally incompatible workspaces. For any given project, a user must first select an optimal set of third party platforms and then manually configure different workspaces at each of the selected workspace. Due to the incompatibility between each of the workspaces, tasks performed while developing and/or monitoring a project, such as transferring data to train a model, monitoring the stage of progress and/or use of a model, and/or the like, must all be performed by individually accessing each of the workspaces. This prevents the centralized aggregation of data across multiple computing platforms and limits the use of functionalities provided by different platforms that may be beneficial for a machine learning project. Various embodiments of the present disclosure make important contributions to various existing machine learning configuration techniques by addressing each of these technical challenges.

### BRIEF SUMMARY

Various embodiments of the present disclosure provide a compute agnostic project workspace for leveraging the functionalities across multiple different third party workspaces from one centralized location. During configuration, a first party computing resource may automatically generate one or more selected third party workspaces hosted by various disparate third party computing resources. During the generation of each third party workspace, the first party computing resource may initiate the installation of a first party routine set with a plurality of webhooks within each of the workspaces. The first party routine set may be configured to establish communication between the compute agnostic project workspace and each of the third party workspaces. By doing so, the present disclosure provides an improved machine learning project workspace capable of leveraging the functionalities provided by a plurality of different third parties from one centralized location to overcome the technical challenges of conventional machine learning configuration techniques.

In some embodiments, a computer-implemented method includes generating, by one or more processors of a first party computing resource, a canonical representation of a machine learning model associated with a compute agnostic project workspace that is communicatively connected to a plurality of third party workspaces hosted by one or more of a plurality of different third party computing resources; in response to user activity within a third party workspace of the plurality of third party workspaces, receiving, by the one or more processors, model activity data from a third party computing resource associated with the third party workspace; generating, by the one or more processors, relative progress data for the machine learning model based on the model activity data; modifying, by the one or more processors, the canonical representation of the machine learning model based on the model activity data and the relative progress data; in response to the canonical representation satisfying a publication threshold, generating, by the one or more processors, a model interface point for accessing the machine learning model; and providing, by the one or more processors, the model interface point for the machine learning model to one or more users through a model registry.

In some embodiments, a computing system includes memory and one or more processors communicatively coupled to the memory. The one or more processors are configured to generate a canonical representation of a machine learning model associated with a compute agnostic project workspace that is communicatively connected to a plurality of third party workspaces hosted by one or more of a plurality of different third party computing resources; in response to user activity within a third party workspace of the plurality of third party workspaces, receive model activity data from a third party computing resource associated with the third party workspace; generate relative progress data for the machine learning model based on the model activity data; modify the canonical representation of the machine learning model based on the model activity data and the relative progress data; in response to the canonical representation satisfying a publication threshold, generate a model interface point for accessing the machine learning model; and provide the model interface point for the machine learning model to one or more users through a model registry.

In some embodiments, one or more non-transitory computer-readable storage media include instructions that, when executed by one or more processors, cause the one or more processors to generate a canonical representation of a machine learning model associated with a compute agnostic project workspace that is communicatively connected to a plurality of third party workspaces hosted by one or more of a plurality of different third party computing resources; in response to user activity within a third party workspace of the plurality of third party workspaces, receive model activity data from a third party computing resource associated with the third party workspace; generate relative progress data for the machine learning model based on the model activity data; modify the canonical representation of the machine learning model based on the model activity data and the relative progress data; in response to the canonical representation satisfying a publication threshold, generate a model interface point for accessing the machine learning model; and provide the model interface point for the machine learning model to one or more users through a model registry.

### BRIEF DESCRIPTION OF DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 is a dataflow diagram showing example data structures for facilitating a compute agnostic project workspace in accordance with some embodiments discussed herein.

FIG. 4 is a dataflow diagram showing example data structures for facilitating a canonical model tracking process in accordance with some embodiments discussed herein.

FIG. 5 is an operational example of model registry ecosystem 500 in accordance with some embodiments discussed herein.

FIG. 6 is a flowchart showing an example of a process for generating a compute agnostic project workspace in accordance with some embodiments discussed herein.

FIG. 7 is a flowchart showing an example of a process for tracking and controlling access to a machine learning model in accordance with some embodiments discussed herein in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component May be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

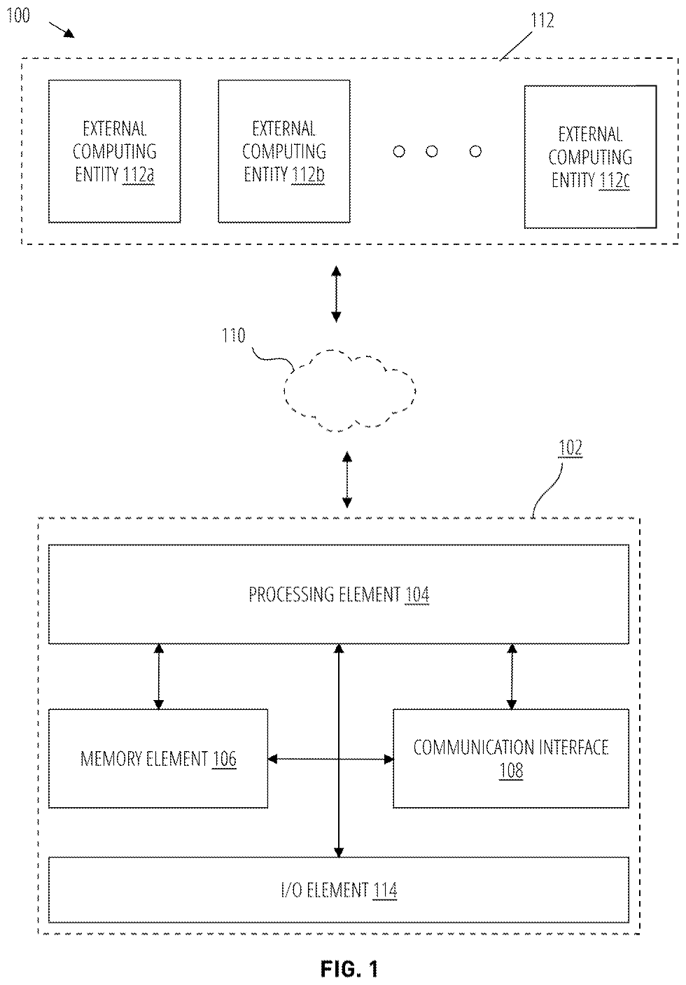

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., configuration techniques, evaluation techniques, development techniques, data management techniques, and/or the like) described herein.

The external computing entities 112a-c, for example, may include and/or be associated with one or more third party computing resources that may be configured to receive, store, manage, and/or facilitate one or more portions of a machine learning based project. The third party computing resources, for example, may be associated with one or more data repositories, cloud platforms, compute nodes, and/or the like, that may, in some circumstances, be leveraged by the predictive computing entity 102 to facilitate one or more stages of a machine learning based project.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

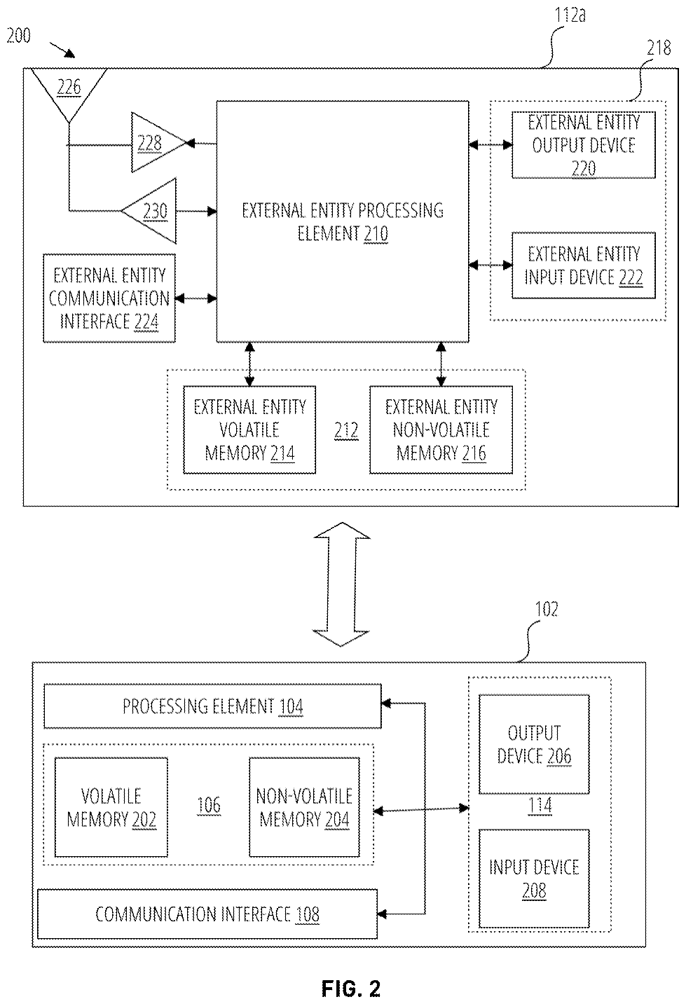

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM). Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established or fixed) or dynamic (e.g., created or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “computing resource” refers to a computing platform configured to facilitate the performance of one or more computing tasks, such as data manipulation, model development, data storage, and/or the like. A computing platform may include one or more processing devices, memory devices, and/or the like that are physically and/or wirelessly coupled and configured to collectively (and/or individually) perform the one or more computing tasks. A computing resource may include an operating system configured to manage and facilitate the use of the one or more processing devices, memory devices, and/or the like. A computing resource may include one or more local and/or remote resources configured to execute computing applications, compute services, and/or the like.

In some embodiments, the term “first party computing resource” refers to a local computing resource. The local computing resource may include a first party computing platform with one or more processing devices, memory devices, and/or the like that are owned, operated, and/or otherwise associated with a first party. The first party computing resource, for example, may include a software platform that is executed by devices located on the premises of one or more locations associated with the first party.

In some embodiments, the term “third party computing resource” refers to a remote computing resource. The remote computing resource may include a third party computing platform with one or more processing devices, memory devices, and/or the like that are owned, operated, and/or otherwise associated with a third party. The third party computing resource, for example, may include a software platform (e.g., Amazon Web Services (AWS), Microsoft Azure, Google Cloud Platform (GCP), etc.) that is executed by a cloud services provider. In some examples, the third party computing resource may include platform services that may be accessible to a first party.

In some embodiments, the term “workspace” refers to a unit of computing space and/or processing power that is facilitated by a computing resource. A workspace may include a file, directory, and/or the like that allows a user to store, develop, test, and/or evaluate at least a portion of a machine learning-based project. For example, a workspace may include a portion of digital storage for storing training data, source code files, machine learning parameters and/or weights, and/or the like. As another example, a workspace May include a portion of compute power (e.g., processing power, etc.) for performing one or more computing tasks, and/or the like.

In some examples, a workspace may incorporate one or more functionalities of a host computing resource. For example, a host computing resource may include and/or have access to one or more host routine sets, such as application programming interfaces (APIs), software development kits (SDKs), and/or the like. A workspace hosted by a host computing resource may have access to at least a portion of the host routine sets.

In some embodiments, the term “first party workspace” refers to a workspace that is hosted by a first party computing resource. The first party workspace may include a local file, directory, and/or the like that is hosted by one or more local computing resources of the first party. The first party workspace may be configured based on an operating system of the first party computing resource and may offer access to a plurality first party routine sets (e.g., application programming interfaces (APIs), software development kits (SDKs), etc.) configured for the first party computing resource.

In some embodiments, the term “third party workspace” refers to a workspace that is hosted by a third party computing resource. The third party workspace may include a remote file, directory, and/or the like that is hosted by one or more third party computing resources of a third party. The third party workspace may be configured based on an operating system of the third party computing resource and may offer access to a plurality of third party routine sets (e.g., APIs, SDKs, etc.) configured for the third party computing resource.

In some embodiments, the term “user subscription” refers to a data entity that describes one or more third party privileges for a user. A user subscription may identify one or more third party credentials, third party allowances (e.g., space, processing power, etc.), and/or the like, that may be leveraged by the first party computing resource to generate a third party workspace for a user and/or group of users. By way of example, the user subscription may include one or more cloud computing privileges for allocating space, computing power, and/or the like from a third party computing resource to a machine learning project.

In some embodiments, the term “compute agnostic project workspace” refers to workspace that is at least partially hosted by a first party computing resource and/or at least one third party computing resource. The compute agnostic project workspace may support multiple compute choices for a machine learning project including on-prem, first party, solutions and third party solutions, such as cloud service platforms (e.g., Kubernetes, Spark, AML, Sagemaker, Databricks, etc.). For example, the compute agnostic project workspace may aggregate data and functionality across a plurality of first and/or third party workspaces to allow users (e.g., data scientists, etc.) to take advantage of different compute choices for handling different stages, workloads, and/or the like of a machine learning project from one centralized workspace, while working with consistent contracts for data access, analysis, model building, deployment, and/or the like.

In some examples, the compute agnostic project workspace may be hosted by the first party computing resource. The compute agnostic project workspace may include cloud agnostic routine sets, such as APIs, SDKs, and/or the like, that communicatively couple the compute agnostic project workspace to each of a plurality of third party workspaces identified for a machine learning project. In this way, the compute agnostic project workspace may provide access to novelty features available through different third party computing resources (e.g., cloud providers, etc.) and mix and match the third party computing resources based on the requirements of a machine learning project. By way of example, the compute agnostic project workspace may provide access to a first third party workspace (e.g., an AWS Sagemaker Canvas, etc.) to leverage specific functionality for training a machine learning model and a second third party workspace (e.g., Azure Blob Storage, etc.) to leverage a different set of functionality for storing training data.

In some embodiments, the term “sub-workspace” refers to a section of a workspace. For example, a workspace, such as a compute agnostic project workspace, may include a plurality of sections defined by a machine learning project workflow. The workspace may include a sub-workspace for each section of the machine learning project workflow. By way of example, a machine learning project workflow may include a configuration stage, a data preparation stage, a model experiment stage, a model review stage, a model deployment stage, and/or the like. A workspace may include a first sub-workspace that corresponds to the configuration stage, a second sub-workspace that corresponds to the data preparation stage, a third sub-workspace that corresponds to the model experiment stage, a fourth sub-workspace that corresponds to the model review stage, a fifth sub-workspace that corresponds to the model deployment stage, and/or the like. In some examples, each sub-workspace may be associated with one or more third party workspaces. As described herein, each sub-workspace may correspond to a respective model stage of a machine learning model.

In some embodiments, the term “first party workspace request” refers to a data entity that represents a user intention for configuring a first party workspace at a first party computing resource. In some examples, the first party workspace request may include a request to configure a compute agnostic project workspace. The first party workspace request may include configuration data that identifies one or more project attributes, one or more third party computing resources, one or more user subscriptions, and/or any other data associated with a first party computing resource, a third party computing resource, and/or a machine learning project.

In some embodiments, the first party workspace request identifies a third party computing resource for one or more model stages of a machine learning project. By way of example, a machine learning project may include a data preparation stage, a model experiment stage, a model review stage, and/or model deployment stage for a machine learning model. The first party workspace request may identify a first third party computing resource for a data preparation stage and/or a second third party computing resource for a model experiment stage. The first third party computing resource, for example, may include a first set of functionality that may be leveraged to prepare a training dataset for a machine learning model, whereas the second third party computing resource may include a second set functionality that may be leveraged to optimize a machine learning model over a prepared training dataset.

In some embodiments, the term “machine learning project” refers to a data entity that represents one or more machine learning models that are configured to perform a machine learning task and/or one or more datasets used to generate, evaluate, and/or refine the machine learning models. By way of example, the machine learning project may include one or more model architectures, parameters, and/or weights that may be configured to generate one or more trained machine learning models. In addition, or alternatively, the machine learning project may include one or more training, testing, and/or validation datasets for generating the one or more trained machine learning models.

In some embodiments, the term “machine learning model” refers to a data entity that describes parameters, hyper-parameters, and/or defined operations of a rules-based algorithm, machine learning model (e.g., model including at least one of one or more rule-based layers, one or more layers that depend on trained parameters, coefficients, and/or the like), and/or the like. The machine learning model may be configured to process input data to generate a prediction, classification, and/or any other machine learning output. The machine learning model may include one or more of any type of machine learning model including one or more supervised, unsupervised, semi-supervised, reinforcement learning models, and/or the like. In some embodiments, the machine learning model includes multiple models configured to perform one or more different stages of a joint machine learning process. The machine learning model may include one or more neural networks, deep learning models (e.g., long short term memory networks, recurrent neural networks, etc.), regression models, random forest models, support vector machines, and/or the like.

In some embodiments, the term “first party routine set” refers to a data entity that describes one or more computing functionalities corresponding to a first party. For example, the first party routine set may include a first party API that defines one or more interface calls between a first party workspace and a first party server. In some examples, the first party routine set may include a first party SDK that provides one or more development tools and/or functionalities for the configuration of a machine learning project.

In some embodiments, the term “third party routine set” refers to a data entity that describes one or more computing functionalities corresponding to a third party computing resource. For example, the third party routine set may include a third party API that defines one or more interface calls between a third party workspace and a third party server. In some examples, the third party routine set may include a third party SDK that provides one or more development tools and/or functionalities for the configuration of a machine learning project.

In some embodiments, the term “canonical representation” refers to a data entity that represents a standardized representation of a machine learning project. The canonical representation may include a plurality of model characteristics that describe one or more aspects of the development and/or performance of a machine learning model orchestrated using a first party computing resource (e.g., a compute agnostic project workspace thereof). For example, the canonical representation may include configuration data, evaluation data, and/or the like, for a machine learning model developed, maintained, and/or at least partially hosted within a compute agnostic project workspace. In some examples, the canonical representation may include interface points (e.g., interactive links, pointer, API endpoints, etc.) for accessing the machine learning model and/or a workspace for a portion of the machine learning model (e.g., hosted by a first and/or third party computing resource, etc.).

In some embodiments, the canonical representation includes one or more model stage representations. The model stage representations, for example, may be indicative of one or more model stages of a machine learning model lifecycle. The model stages may be defined by a first party entity associated with the first party computing resource and may apply to each machine learning model across each machine learning project orchestrated by the first party computing resource.

In some embodiments, a model stage representation includes a plurality of stage-specific model criteria for a respective model stage of the model lifecycle. The stage-specific model criteria may include one or more stage-specific model attributes and/or one or more stage-specific model requirements that correspond to the respective model stage. The stage-specific model attributes, for example, may include one or more characteristics, such as data attributes, performance attributes, training attributes, model parameter attributes, and/or the like, that correspond to the respective model stage. The stage-specific model requirements may include one or more defined standards for completing the respective model stage. The one or more model requirements, for example, may be defined by a first party entity to standardize model development across a plurality of different machine learning projects orchestrated by the first party computing resource.

In some embodiments, a model stage representation includes of a stage status indicator for a respective model stage. The stage status indicator may be indicative of a proportion of the one or more stage-specific model requirements that are satisfied by a machine learning model. The proportion of the one or more stage-specific model requirements, for example, may be based on the one or more model attributes.

In some embodiments, a model stage representation includes one or more stage-specific interface points. A stage-specific interface point, for example, may include one or more first and/or third party interface points for accessing a workspace and/or sub-workspace associated with a respective model stage of a machine learning model. For example, a stage-specific interface point (e.g., interactive links, pointer, API endpoints, etc.) may include a third party stage-specific interface point for accessing one or more third party workspaces associated with a respective model stage. In addition, or alternatively, a stage-specific interface point (e.g., interactive links, pointer, API endpoints, etc.) may include a first party stage-specific interface point for accessing a sub-workspace of a compute agnostic project workspace associated with a respective model stage.

In some embodiments, the term “model lifecycle” refers to a data entity that describes an end-to-end machine learning model development and deployment process. A model lifecycle may include a plurality of model stages that define one or more distinct portions of a machine learning model development and/or deployment process. A model lifecycle may be model agnostic and may be applied to any type of machine learning model. In some examples, the model may be defined at an enterprise level, such as by a first party entity, to track each of a plurality of machine learning models as each model independently transitions between model stages during the development and subsequent deployment of the machine learning model.

In some embodiments, the term “model stage” refers to a data entity that describes a portion of a model lifecycle. A model stage may include a distinct segment of a machine learning model lifecycle that defines one or more actions, attributes, parameters, requirements, and/or the like for a machine learning model at a particular stage of the model's development and/or deployment. By way of example, a model stage may correspond to one or more configuration, training, evaluation, and preliminary testing stages of a model's development before the model is trained and deployed. As another example, a model stage may correspond to post-deployment evaluation, validation, and/or tracking stages of a model's lifecycle subsequent to the development and initial training of the model. A model stage may be defined at an enterprise level, for example by a first party entity, and may depend on the prediction domain and/or goals of the enterprise. Each stage, for example, may be directed to a particular task, operation, and/or goal of an enterprise and may be defined to derive holistic insights for the enterprise across a variety of machine learning models governed by the enterprise.

In some embodiments, a model stage is a model configuration stage, a model data preparation stage, a model experiment stage, a model review stage, and/or a model deployment stage. During a model configuration stage, a machine learning model architecture may be identified, accessed, generated, modified, tested, validated, and/or the like. During a model data preparation stages, training data for the model may be identified, accessed, generated, modified, tested, validated, and/or the like. During a model experiment stage, the model may be trained, tested, validated, modified, and/or the like using the training data. During a model review stage, the model may be tested, evaluated, validated, and/or the like with respect to one or more deployment publication criteria. During a model deployment stage, the model may be deployed for use to one or more users.

In some embodiments, the term “model attribute” refers to a data entity that describes a characteristic of a machine learning model. A model attribute may include any characteristic associated with a machine learning model.

For instance, a model attribute may include a model configuration attribute, such a model architecture attribute (e.g., model type, number of branches, nodes, etc.), a model arrangement attribute for an ensemble model, a model version attribute, and/or the like. In some examples, a model configuration stage may be associated with one or model configuration attributes.

As another example, a model attribute may include a data attribute, such a dataset attribute (e.g., a dataset name, dataset source, dataset characteristics, dataset metrics, etc.), a data filtering attribute (e.g., a filtering parameter for focusing on different types of data, etc.), a data size attribute, a data validation, testing, and training ratio attribute, a data quality attribute, and/or the like. In some examples, a model data preparation stage may be associated with one or more data attributes.

As another example, a model attribute may include an experiment attribute, such as a training type attribute (e.g., a loss function, optimization function, etc.), a performance attribute (e.g., AUCROC, F1, precision, accuracy, recall, etc.), and/or the like. In some examples, a model experiment stage may be associated with one or more experiment attributes.

As another example, a model attribute may include an evaluation attribute, such as a fairness attribute (e.g., a relative performance with respect to different training objects, etc.), a reliability attribute (e.g., a consistency of performance, etc.), an interpretability attribute, a robustness attribute, and/or the like. In some examples, a model review stage may be associated with one or more evaluation attributes.

As another example, a model attribute may include a usage attribute, such as an accessed attribute (e.g., a number of calls to a deployed model, etc.), an expense attribute (e.g., a processing and storage expenditure for deploying the model, etc.), a return attribute, and/or the like. In some examples, a model deployment stage may be associated with one or more usage attributes.

In some embodiments, the term “model requirement” refers to a data entity that describes a requirement for a machine learning model. A model requirement may include any standard for evaluating the completeness and/or performance of a machine learning model. A model requirement may include a threshold metric, required model attribute, and/or the like that may be defined at an enterprise level to ensure compliance across a plurality of different machine learning models. In some examples, one or more model requirements may form a stage lifecycle for a model stage. For instance, a model requirement may be indicative of a requirement for completing a respective model stage. In some examples, a machine learning model may be restricted from transitioning to subsequent model stage until each of the model requirements are satisfied for a previous model stage. In some examples, a machine learning model may be transitioned back to a previous model stage in the event that the one of the model requirements is no longer satisfied for a current model stage.

For example, one or more model requirements for a model configuration stage may include one or more configuration requirements indicative of one or more approved model architectures, sources, sizes, versions, arrangements, and/or the like. In addition, or alternatively, the configuration requirements may require verified access to a model configuration (e.g., a model configuration from a third party data source, etc.), a verified upload of a model configuration, a verified compilation of the model configuration, and/or the like.

As another example, one or more model requirements for a model data preparation stage may include one or more data requirements indicative of one or more approved datasets, data sources, sizes, versions, arrangements, and/or the like. In addition, or alternatively, the data requirements may be indicative of verified access to a dataset (e.g., a dataset from a third party data source, etc.), a verified upload of a dataset, and/or the like. In some examples, the data requirements may include one or more required data quality thresholds, such as one or more accuracy thresholds, completeness thresholds, consistency thresholds, freshness thresholds (e.g., within a particular time period, etc.), uniqueness thresholds, validity thresholds, and/or the like. In some examples, the data requirements may be indicative of one or more set validation, testing, and training thresholds (e.g., particular percentages of data, etc.).

As another example, one or more model requirements for a model experiment stage may include one or more experiment requirements indicative of one or more model performance thresholds, such as one or more AUCROC thresholds, F1 thresholds, precision thresholds, accuracy thresholds, recall thresholds, and/or the like.

As another example, one or more model requirements for a model review stage may include one or more review requirements indicative of one or more fairness thresholds, reliability thresholds, interpretability thresholds, robustness thresholds, and/or the like.

As another example, one or more model requirements for a model deployment stage may include one or more usage requirements indicative of one or more access thresholds, expense thresholds, return thresholds, and/or the like.

In some embodiments, the term “model interface point” refers to a construct that provides access to a machine learning model. A model interface point, for example, may include one or more interactive links, one or more pointers, and/or the like that connect a repository to one or more data sources for executing a machine learning model. In some examples, the model interface point may include an application programming interface (API) endpoint. For instance, the model interface point may include an API endpoint that may called from a model registry.

In some embodiments, the term “model activity data” refers a data entity that describes development and/or usage data for a machine learning model. The model activity data, for example, may include metadata sourced from a model registry and/or one or more first and/or third party computing resources.

For instance, the model activity data may include model development data from one or more first and/or third party computing resources. The model development data may be indicative of activity within a first and/or third party workspace that may modify, augment, and/or remove one or more components of a machine learning model. The model development data may be indicative of one or more new, modified, and/or removed model attributes for a machine learning model. By way of example, model development data may record a computing action for configurating a training dataset for the machine learning model within a third party workspace. In such a case, the model development data may be indicative of a new data attribute for a machine learning model.

In addition, or alternatively, the model activity data may include usage data from a model registry. The usage data may be indicative of activity within a local and/or centralized registry that impacts a machine learning model by, for example, executing the model, storing the model, maintaining the model, validating the model, and/or the like. The usage data may be indicative of one or more new, modified, and/or removed model attributes for a machine learning model. By way of example, usage data may record a computing action for executing the machine learning model in response to an interaction with a model interface point within a model registry. In such a case, the usage data may be indicative of a modified usage attribute indicative of an incremented number of uses of the machine learning model.

In some embodiments, the term “model status indicator” refers to a data entity that describes a machine learning model's status relative to a model lifecycle. For instance, the model status indicator may be indicative of a proportion of the one or more model requirements that are satisfied by the machine learning model. In some examples, the model status indicator is indicative of a proportion of the one or more model stages that are satisfied by the machine learning model. By way of example, the model status indicator may be indicative of an aggregation of each of the stage status indicators for each model stage represented by the canonical representation.

In some embodiments, the term “model registry” refers to a data structure for providing access to one or more machine learning models. For instance, the model registry may include one or more database(s), for example local database(s), cloud database(s), and/or any combination thereof. The model registry may be specially configured to store any number of data object(s), each embodying a stored machine learning model. In some embodiments, for example, a respective model registry may be specially configured to store a canonical representation for each machine learning model that successfully completes a publication to the respective model registry. By way of example, a respective model registry may include a plurality of model interface points for a plurality of models published to the model registry.

In some embodiments, the term “local registry” refers to a model registry for providing access to one or more machine learning models in a localized, developmental computing environment. In some embodiments, a local registry may be sectioned into one or more different development environments with one or more different visibility levels. Each visibility level may require one or more user permissions for accessing the local registry.

In some embodiments, the term “visibility level” refers a portion of the local registry. For instance, the local registry may be divided into a plurality of visibility levels. Each visibility level may be associated with one or more different publication thresholds for allow access to user with a particular level of user permissions.

In some embodiments, the term “centralized registry” refers to a model registry for providing access to one or more machine learning models in a global, deployment computing environment. In some embodiments, a centralized registry may be associated with a publication threshold that is higher than the local registry.

In some embodiments, the term “publication threshold” refers to a data entity that represents one or more first party requirements for providing access to a machine learning model from a particular model registry. A publication threshold may be indicative of one or more model requirements, model status indicators, stage status indicators, and/or the like. A publication threshold, for example, may be tailored to a model registry and the one or more model requirements. For example, a publication threshold for a first visibility level of a local registry may be indicative of one or more model requirements for a first model stage of a model lifecycle. As another example, a publication threshold for a centralized registry may be indicative may be indicative of one or more model requirements for each model stage of a model lifecycle.

### IV. Overview, Technical Improvements, and Technical Advantages

Embodiments of the present disclosure present machine learning configuration techniques that provide improvements over traditional machine learning environments that are restricted to a single computing platform. The machine learning configuration techniques may be leveraged to generate a compute agnostic project workspace for developing, managing, and deploying a machine learning project. Unlike conventional machine learning environments, the compute agnostic project workspace may leverage the functionalities provided by multiple disparate computing platforms from one centralized location. To do so, some embodiments of the present disclosure describe initiating the generation of a third party workspace by a first party computing resource and, during the configuration of the third party workspace, installing a first party routine set (e.g., software development kit (SDK), etc.) to automatically link the third party workspace to a compute agnostic project workspace.

During the development, management, and deployment of a machine learning project, the first party routine set may allow a user to initiate commands to and aggregate data from each of a plurality of linked third party workspaces. In this way, some embodiments of the present disclosure provide cloud agnostic workspace where users may work with their choice of cloud provider or on-prem solution to access and store data, while bringing functionalities provided by other providers to the data instead of moving data to multiple different cloud environments. This may allow one, first party platform, to serve as a default framework for leveraging each of the unique functionalities provided by different machine learning development, management, and deployment solutions. The first party platform may provide an end-to-end machine learning project platform with bring your own compute that overcomes the compatibility disadvantages unique to computer technology. By doing so, embodiments of the present disclosure prevent project fragmentation by facilitating the seamless integration of multiple disparate, incompatible, computing functionalities from one centralized environment.

Moreover, by enabling the development and management of machine learning models from one centralized environment, some of the techniques of the present disclosure allow for the creation of holistic canonical representations of a machine learning model that may be leveraged to track changes to the model across multiple disparate sources. The canonical representations of the present disclosure may standardize model parameters and requirements across multiple machine learning models affiliated with an enterprise, thereby allowing enterprise visibility, access, and control over various different machine learning models distributed across myriad different computing platforms. This, in turn, allows for standardized sets of access constraints, such as publication thresholds, to be applied equally across all model associated with a particular entity. In this way, some of the techniques of the present disclosure may be practically applied to improve upon the transparency, control, and standardization of traditional machine learning environments.

### V. Example System Operations

As indicated, various embodiments of the present disclosure make important technical contributions to machine learning techniques for developing, managing, and deploying machine learning models. In particular, systems and methods are disclosed herein that implement monitoring techniques for seamlessly leveraging multiple, traditionally incompatible, functionalities from across different third party computing resources to generate holistic, up-to-date representations of a machine learning model.

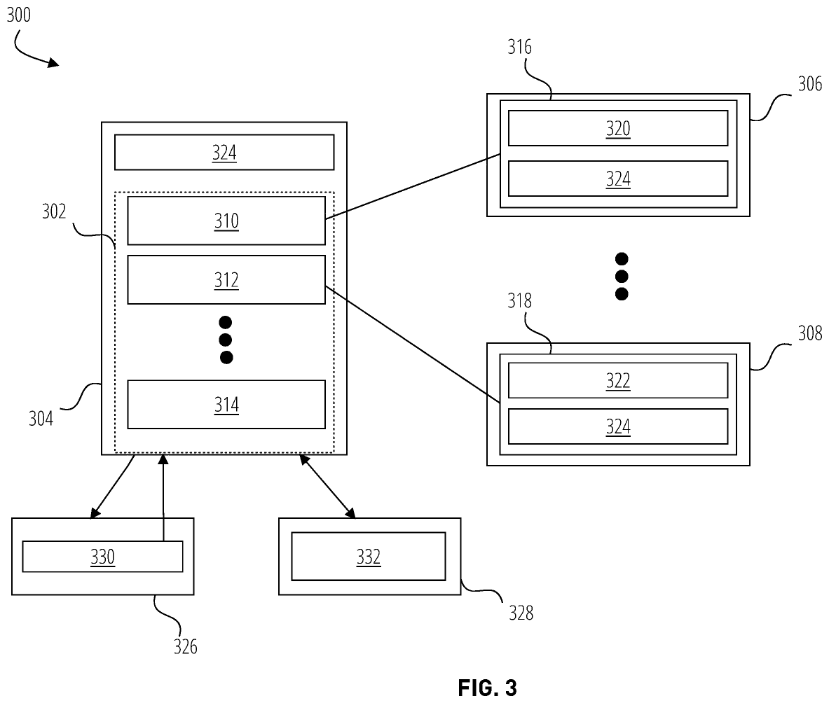

FIG. 3 is a dataflow diagram 300 showing example data structures for facilitating a compute agnostic project workspace in accordance with some embodiments discussed herein. The dataflow diagram 300 depicts a set of data structures and computing entities for generating a centralized workspace for leveraging various machine learning development, evaluation, and validation functionalities across a plurality of disparate computing resources. The centralized workspace may be a compute agnostic project workspace 302 that is provided by a first party computing resource 304. The first party computing resource 304 may facilitate access to a plurality of different machine learning tools offered by third party computing resources to provide a cloud agnostic end-to-end machine learning environment where users may work with any of a plurality of different combinations of third party computing resources, such as the first third party computing resource 306 and/or the second third party computing resource 308. In some examples, the first third party computing resource 306 and the second third party computing resource 308 may be different third party computing resources.

In some embodiments, a computing resource is a computing platform configured to facilitate the performance of one or more computing tasks, such as data manipulation, model development, data storage, and/or the like. A computing platform may include one or more processing devices, memory devices, and/or the like that are physically and/or wirelessly coupled and configured to collectively (and/or individually) perform the one or more computing tasks. A computing resource may include an operating system configured to manage and facilitate the use of the one or more processing devices, memory devices, and/or the like. A computing resource may include one or more local and/or remote resources configured to execute computing applications, compute services, and/or the like.

In some embodiments, the first party computing resource 304 is a local computing resource. The local computing resource may include a first party computing platform with one or more processing devices, memory devices, and/or the like that are owned, operated, and/or otherwise associated with a first party. The first party computing resource, for example, may include a software platform that is executed by devices located on the premises (e.g., on-prem devices) of one or more locations associated with the first party.

In some embodiments, a third party computing resource, such as the first third party computing resource 306 and/or the second third party computing resource 308, is a remote computing resource. The remote computing resource may include a third party computing platform with one or more processing devices, memory devices, and/or the like that are owned, operated, and/or otherwise associated with a third party. The third party computing resource, for example, may include a software platform (e.g., Amazon Web Services (AWS), Microsoft Azure, Google Cloud Platform (GCP), etc.) that is executed by a cloud services provider. In some examples, the third party computing resource may include platform services that may be accessible to a first party. As an example, the first third party computing resource 306 may be a first software platform and the second third party computing resource 308 may be a second software platform.

Each of the first party computing resource 304, the first third party computing resource 306, and the second third party computing resource 308 may be configured to operate according to different computing architectures, operating systems, API's, and/or the like. Each computing resource, for example, may be a distinct computing node that may be configured to operate in a manner that may be incompatible with the one or more other computing resources. Traditionally, machine learning platforms address compatibility issues by constraining the compute choices for a machine learning project. However, this may lead to fragmentation and increases in cognitive overload. To address these concerns, some of the embodiments of the present disclosure facilitate a compute agnostic project workspace 302 that enables a user to leverage the functionalities of multiple, potentially incompatible, computing platforms from one centralized project workspace.

In some embodiments, a workspace is a unit of computing space and/or processing power that is facilitated by a computing resource. A workspace may include a file, directory, and/or the like that allows a user to store, develop, test, and/or evaluate at least a portion of a machine learning-based project. For example, a workspace may include a portion of digital storage for storing training data, source code files, machine learning parameters and/or weights, and/or the like. As another example, a workspace may include a portion of compute power (e.g., processing power, etc.) for performing one or more computing tasks, and/or the like.

In some examples, a workspace may incorporate one or more functionalities of a host computing resource. For example, a host computing resource may include and/or have access to one or more host routine sets, such as application programming interfaces (APIs), software development kits (SDKs), and/or the like. A workspace hosted by a host computing resource may have access to at least a portion of the host routine sets. By way of example, the host computing resource for a workspace may include the first party computing resource 304, the first third party computing resource 306, and/or the second third party computing resource 308.

In some embodiments, a first party workspace is a workspace that is hosted by the first party computing resource 304. The first party workspace may include a local file, directory, and/or the like that is hosted by one or more local computing resources of a first party. The first party workspace may be configured based on an operating system of the first party computing resource and may offer access to a plurality of first party routine sets 324 configured for the first party computing resource.

In some embodiments, a third party workspace, such as the first third party workspace 316, the second third party workspace 318, and/or the like, is to a workspace that is hosted by a respective third party computing resource. For example, the first third party workspace 316 may be hosted by the first third party computing resource 306, the second third party workspace 318, may be hosted by the second third party computing resource 308, and/or the like. A third party workspace may include a remote file, directory, and/or the like that is hosted by the respective third party computing resources. The first third party workspace 316 may be configured based on an operating system of the first third party computing resource 306 and may offer access to a plurality of first third party routine sets 320 (e.g., APIs, SDKs, etc.) configured for the first third party computing resource 306. The second third party workspace 318 may be configured based on an operating system of the second third party computing resource 308 and may offer access to a plurality of second third party routine set 322 (e.g., APIs, SDKs, etc.) configured for the second third party computing resource 308.

In some embodiments, the first party computing resource 304 is configured to generate a compute agnostic project workspace 302 to leverage the various functionalities provided by one or more third party computing resources. The compute agnostic project workspace 302 may provide an interface between the first party computing resource 304 and the third party computing resources to facilitate the use of a plurality of different routine sets, such as the first party routine set 324, the first third party routine set 320, the second third party routine set 322, and/or the like from one central workspace.

In some embodiments, the compute agnostic project workspace is a workspace that is at least partially hosted by the first party computing resource 304 and/or at least one third party computing resource. The compute agnostic project workspace 302 may support multiple compute choices for a machine learning project including on-prem, first party, solutions and third party solutions, such as cloud server platforms (e.g., Kubernetes, Spark, AML, Sagemaker, Databricks, etc.). For example, the compute agnostic project workspace 302 may aggregate data and functionality across a plurality of first party and/or third party workspaces to allow users (e.g., data scientists, etc.) to take advantage of different compute choices for handling different stages, workloads, and/or the like of a machine learning project from one centralized workspace, while working with consistent contracts for data access, analysis, model building, deployment, and/or the like.

In some examples, the compute agnostic project workspace 302 may be hosted by the first party computing resource 304. The compute agnostic project workspace 302 may include cloud agnostic routine sets, such as APIs, SDKs, and/or the like, that communicatively couple the compute agnostic project workspace 302 to each of a plurality of third party workspaces identified for a machine learning project. In this way, the compute agnostic project workspace 302 may provide access to novelty features available through different third party computing resources (e.g., cloud providers, etc.) and mix and match the first third party computing resources 306 based on the requirements of a machine learning project. By way of example, the compute agnostic project workspace 302 may provide access to a first third party workspace 316 (e.g., an AWS Sagemaker Canvas, etc.) to leverage specific functionality (e.g., first third party routine set 320, etc.) for training a machine learning model and a second third party workspace 318 (e.g., Azure Blob Storage, etc.) to leverage a different set of functionality (e.g., second third party routine set 322) for storing training data.

The compute agnostic project workspace 302 may be generated based on configuration data. For example, the first party computing resource 304 may be configured to generate the compute agnostic project workspace 302 in response to a first party workspace request 330 that includes configuration data for the compute agnostic project workspace 302.

In some embodiments, the first party workspace request 330 refers to a data entity that represents a user intention for configuring a first party workspace at the first party computing resource 304. In some examples, the first party workspace request 330 may include a request to configure the compute agnostic project workspace 302. The first party workspace request 330 may include configuration data that identifies one or more project attributes, one or more third party computing resources, one or more user subscriptions, and/or any other data associated with a first party computing resource 304, a third party computing resource, and/or a machine learning project.

In some embodiments, the first party workspace request 330 identifies a third party computing resource for one or more stages of a machine learning project. By way of example, a machine learning project may include a data preparation stage, a model experiment stage, a model review stage, and/or model deployment stage for a machine learning model. The first party workspace request 330 may identify a first third party computing resource 306 for a data preparation stage, a second third party computing resource 308 for a model experiment stage, and/or the like. The first third party computing resource 306, for example, may include a first set of functionality (e.g., first third party routine set 320, etc.) that may be leveraged to prepare a training dataset for a machine learning model, whereas the second third party computing resource 308 may include a second set functionality (e.g., second third party routine set 322) that may be leveraged to optimize a machine learning model over a prepared training dataset.

In some embodiments, a machine learning project is a data entity that represents one or more machine learning models that are configured to perform a machine learning task and/or one or more datasets used to generate, evaluate, and/or refine the machine learning models. By way of example, the machine learning project may include one or more model architectures, parameters, and/or weights that may be configured to generate one or more trained machine learning models. In addition, or alternatively, the machine learning project may include one or more training, testing, and/or validation datasets for generating the one or more trained machine learning models.

In some embodiments, a machine learning model is a data entity that describes parameters, hyper-parameters, and/or defined operations of a rules-based algorithm, machine learning model (e.g., model including at least one of one or more rule-based layers, one or more layers that depend on trained parameters, coefficients, and/or the like), and/or the like. The machine learning model may be configured to process input data to generate a prediction, classification, and/or any other machine learning output. The machine learning model may include one or more of any type of machine learning model including one or more supervised, unsupervised, semi-supervised, reinforcement learning models, and/or the like. In some embodiments, the machine learning model may include multiple models configured to perform one or more different stages of a joint machine learning process. The machine learning model may include one or more neural networks, deep learning models (e.g., long short term memory networks, recurrent neural networks, etc.), regression models, random forest models, support vector machines, and/or the like.

In some embodiments, the first party computing resource 304 receives a first party workspace request 330 for a machine learning project that involves one or more machine learning models. The first party computing resource 304 may receive the first party workspace request 330 from a user, computing entity, and/or the like. The first party workspace request 330 may be indicative of a third party computing resource, such as the first third party computing resource 306 and/or the second third party computing resource 308.

In some embodiments, the first party workspace request 330 is received from a user through a configuration interface 326 provided by the first party computing resource 304. For example, the configuration interface 326 may include one or more selection interfaces. The first party workspace request 330 may include selection input, from one or more of the selection interfaces, which identifies one or more portions of the configuration data for a compute agnostic project workspace 302.

In some embodiments, a configuration interface 326 is a user interface for facilitating a first party workspace request 330. The configuration interface 326 may be hosted by the first party computing resource 304 to facilitate the input of one or more configuration parameters for the compute agnostic project workspace 302. For instance, the configuration interface 326 may include one or more selection interfaces that respectively include one or more selection widgets for providing a selection input indicative of a configuration parameter for the compute agnostic project workspace 302. By way of example, a first selection interface may include one or more interactive compute selection widgets indicative of a first plurality of third party computing resources for model configuration. As another example, a second selection interface may include one or more interactive data selection widgets indicative of a second plurality of third party computing resources for data configuration.

In some examples, the first party computing resource 304 may receive a first selection input from a first selection interface of the configuration interface 326 hosted by the first party computing resource 304. The first selection input may identify the first third party computing resource 306 for configuring a machine learning model. The first third party computing resource 306, for example, may be selected for training one or more machine learning models of the machine learning project. In some examples, the first party computing resource 304 may receive a second selection input from a second selection interface of the configuration interface 326 hosted by the first party computing resource 304. The second selection input may identify the second third party computing resource 308 for configuring a training dataset for a machine learning model. The second third party computing resource 308, for example, may be selected for processing a dataset for training one or more machine learning models of the machine learning project.

In some embodiments, the first party computing resource 304 may provide the first selection interface and/or the second selection interface for display to a user. The first selection interface may include one or more interactive compute selection widgets that identify a plurality of available third party computing resources for model configuration. The second selection interface may include one or more interactive data selection widgets that identify a plurality of available third party computing resources for data configuration. In some examples, the plurality of available third party computing resources may be dynamically determined based on one or more attributes of the machine learning project and/or a user subscription associated with the user.

In response to the first party workspace request for a machine learning project, the first party computing resource 304 may generate the compute agnostic project workspace 302 hosted by the first party computing resource 304, initiate the generation of a third party workspace hosted by one or more third party computing resources based on the configuration data, and/or initiate a configuration of a first party routine set within the third party workspace. By way of example, the first party computing resource 304 may initiate the generation of at least one third party workspace for each third party computing resource identified by the configuration data.

In some examples, the first party workspace request may be indicative of a plurality of third party computing resources. The first party computing resource 304 may initiate the generation of a respective third party workspace for each of the plurality of third party computing resources. For instance, the configuration data may identify the first third party computing resource 306 and the second third party computing resource 308. In such a case, the first party computing resource 304 may initiate the generation of the first third party workspace 316 and the second third party workspace 318.

In some embodiments, the first party workspace request is associated with one or more user subscriptions. The one or more user subscriptions may be indicative of one or more resource permissions for a third party computing resource. The one or more resource permissions, for example, may be indicative of an amount of allocated space for a user, an amount of allocated compute power for the user, and/or the like. In some examples, a third party workspace may be generated using one or more user subscriptions for the third party workspace.

In some embodiments, the user subscription is a data entity that describes one or more third party privileges for a user. A user subscription may identify one or more third party credentials, third party allowances (e.g., space, processing power, etc.), and/or the like, that may be leveraged by the first party computing resource 304 to generate a third party workspace for a user and/or group of users. By way of example, the user subscription may include one or more cloud computing privileges for allocating space, computing power, and/or the like from a third party computing resource to a machine learning project.

In some embodiments, the first party computing resource 304 leverages the one or more user subscriptions to initiate the generation of a third party workspace at a third party computing resource. For example, the first party computing resource 304 may leverage user subscriptions for a first third party computing resource 306 to initiate the generation of the first third party workspace 316. As another example, the first party computing resource 304 may leverage user subscriptions for the second third party computing resource 308 to initiate the generation of the second third party workspace 318.

The user subscriptions, for example, may be leveraged to configure the connectivity, network security, and/or infrastructure parameters for the third party workspace. The user subscriptions may correspond to a user and/or a group of users associated with a first party workspace request 330. In some examples, a user and/or a user group may be associated with a profile with the first party that may identify the user subscriptions. In some examples, the profile may be at least partially controlled by the first party to enable one or more different user subscriptions for the user and/or user group. In this manner, the first party may authorize the use and/or the extent of use of the third party computing resources.

In some embodiments, the first party computing resource 304 initiates the configuration of the first party routine set 324 within each of the third party workspaces. For example, the first party computing resource 304 may initiate a configuration of the first party routine set 324 within the respective third party workspace for each of the plurality of third party computing resources to facilitate communication between the first party computing resource 304 and each of the plurality of third party computing resources.

In some embodiments, the first party routine set 324 is a data entity that represents one or more computing functionalities corresponding to a first party. For example, the first party routine set 324 may include a first party API that defines one or more interface calls between a first party workspace and a first party server. In some examples, the first party routine set 324 may include a first party SDK that provides one or more development tools and/or functionalities for the configuration of a machine learning project.

In some examples, the first party routine set 324 may define a plurality of webhooks for facilitating communication between the first party computing resource 304 and the third party computing resources. The plurality of webhooks may include callback functions that automatically initiate the transfer of data between the first party computing resource 304 and the third party computing resources. The callback functions may be event-driven. For example, webhooks may initiate the transfer of data between the first party computing resource 304 and the third party computing resources in response to one or more changes within a respective third party workspace, such as a coding modification, a parameter or weighting modification, a dataset modification, and/or the like. In some examples, the webhooks are triggered by one or more other functions of the first party routine set 324, such as a publication request routine, and/or the like.

During configuration, the first party computing resource 304 may automatically install the first party routine set 324 within a third party workspace to initiate the transfer of data from the third party workspace to the compute agnostic project workspace 302. In this manner, the compute agnostic project workspace 302 may aggregate data across a plurality of different workspaces hosted by various different third party computing resources.

In some embodiments, the compute agnostic project workspace 302 includes a plurality of sub-workspaces that are tailored to one or more different stages of a machine learning project. In some examples, each sub-workspace may be configured to aggregate data from one or more different third party computing resources to facilitate a particular stage of the machine learning project. For example, a sub-workspace may be configured for a stage of the machine learning project handled by the first party and/or a stage of the machine learning project handled by a third party. A first sub-workspace 310, for instance, may be configured for a first stage (e.g., data preparation stage, etc.) of the machine learning project handled by the first third party computing resource 306 through the first third party workspace 316. A second sub-workspace 312 may be configured for a second stage (e.g., model experiment stage, etc.) of the machine learning project handled by the second third party computing resource 308 through the second third party workspace 318. A third sub-workspace 314 may be configured for a third stage (e.g., a model review stage, etc.) handled by the first party computing resource 304 through a first party workspace.

In some embodiments, a sub-workspace is a section of a workspace. For example, a workspace, such as the compute agnostic project workspace 302, may include a plurality of sections defined by a machine learning project workflow. The workspace may include a sub-workspace for each section of the machine learning project workflow. By way of example, a machine learning project workflow may include a configuration stage, a data preparation stage, a model experiment stage, a model review stage, a model deployment stage, and/or the like. A workspace may include the first sub-workspace 310 that corresponds to the data preparation stage, the second sub-workspace 312 that corresponds to the model experiment stage, a third sub-workspace 314 that corresponds to the model review stage, a fourth sub-workspace that corresponds to the model deployment stage, and/or the like. As described herein, each sub-workspace may correspond to a respective model stage of a machine learning model.

In some embodiments, a sub-workspace corresponds with one or more third party workspaces. As an example, the first sub-workspace 310 may correspond to the first third party workspace 316 and the second sub-workspace 312 may correspond to the second third party workspace 318. Using the first party routine set 324 (e.g., one or more webhooks thereof), each sub-workspace may aggregate data from and/or initiate commands to a corresponding third party workspace that is hosted by a third party computing resource. The aggregated data and/or initiated commands may be provided to/from a user through the compute agnostic project workspace 302 to provide a holistic view and/or control over a machine learning project that is developed, managed, and/or refined across a plurality of disparate third party computing resources.

In some embodiments, each third party workspace has access to particular third party routine sets provided by a respective third party computing resource. For example, the first third party workspace 316 may have access to one or more first third party routine sets 320 that are provided and/or compatible within the first third party workspace 316. The first third party routine set 320 may be leveraged within the first third party workspace 316 to configure at least a portion of a machine learning project (e.g., a data preparation stage, etc.). As another example, the second third party workspace 318 may have access to one or more second third party routine sets 322 that are provided and/or compatible within the second third party workspace 318. The second third party routine set 322 may be leveraged within the second third party workspace 318 to configure at least a portion of the machine learning project.

In some embodiments, the third party routine set is a data entity that represents one or more computing functionalities corresponding to a third party computing resource. For example, the third party routine set may include a third party API that defines one or more interface calls between a third party workspace and a third party server. In some examples, the third party routine set may include a third party SDK that provides one or more development tools and/or functionalities for the configuration of at least a portion of a machine learning project.

In some embodiments, at least a portion of a machine learning project may be developed, refined, evaluated, and/or deployed from a third party workspace using a third party routine set of the third party workspace and the first party routine set 324. For example, by controlling the configuration of the third party workspaces, the first party computing resource 304 may automatically augment the functionalities of each third party workspace with the first party routine set 324. In this way, a first party routine from the first party routine set 324 may be executed from the compute agnostic project workspace 302 (e.g., through a first party command line interface (CLI), etc.) and/or a respective third party workspace (e.g., through a third party CLI, etc.).

In some embodiments, the first party routine set 324 includes a plurality of first party routines that are accessible through one or more interfaces (e.g., first party CLIs, user interfaces, etc.) of the compute agnostic project workspace 302. In some examples, a call to a particular first party routine may depend on an interface that facilitated the call. For example, a publication request routine may be called from an interface corresponding to one or more of the sub-workspaces of the compute agnostic project workspace. The publication request routine may automatically incorporate the location from which it was called as a parameter for facilitating a publication request. By way of example, a publication request routine called from an interface corresponding to a first sub-workspace 310 may initiate a publication action at the corresponding first third party workspace 316, whereas a publication request routine called from an interface corresponding to the second sub-workspace 312 may initiate a publication action at the corresponding second third party workspace 318.

In some embodiments, each sub-workspace of the compute agnostic project workspace 302 is associated with a corresponding user interface. For instance, the first sub-workspace 310 and the first third party workspace 316 may be associated with a first stage (e.g., the data preparation stage, etc.) of the machine learning project. The first sub-workspace 310 may be associated with a first project interface corresponding to the first stage. The first project interface may include data associated with the first stage and/or one or more interactive third party links to the first third party workspace 316. One or more of the interactive third party links may call a first party routine to initiate an action at the first third party workspace 316. In some examples, each sub-workspace of the compute agnostic project workspace 302 may include an interactive third party link for initiating the performance of an action at respective third party workspaces.

In some embodiments, the first party computing resource 304 may receive user input indicative of a selection of at least one of the one or more interactive third party links from a respective sub-workspace. In response to the user input, the first party computing resource 304 may initiate, via the first party routine set 324, the performance of a computing action at the respective third party workspace. The computing action may include any of a plurality of actions facilitated by the first party routine set 324. As some examples, the computing action may include an access request for accessing a respective third party workspace, a publication request for publishing at least a portion of the machine learning project to the compute agnostic project workspace 302 and/or a unified repository, an evaluation request for evaluating one or more aspects of the machine learning project hosted by a respective third party workspace, and/or the like.

In some embodiments, the first party routine set defines a plurality of first party routines for managing and evaluating aspects of a machine learning project from one centralized workspace. The plurality of first party routines may include any number and/or any type of routine depending on the requirements of the first party. For instance, the first party routines may include data evaluation and/or fairness routines that evaluate whether a machine learning project complies with one or more first party standards. In some examples, the first party routines may restrict the use and/or visibility of an aspect of a project based on evaluation measures implemented by the first party routines. For instance, the first party routines may include a publication request routine for publishing a portion of a machine learning project from a third party workspace to one or more repositories provided by the first party computing resource 304. In some examples, the publication request routine may leverage one or more project quality routines to enforce standardized publication criteria established by the first party.

In some embodiments, a publication request routine is a data entity that represents a particular computing functionality implemented by the first party routine set 324. The publication request routine may initiate the transfer of data from a third party workspace to the compute agnostic project workspace 302 and/or another memory location of the first party computing resource 304. By way of example, the publication request routine may trigger a webhook (e.g., a programmable intermediary, etc.) of a first party routine set 324 installed within a third party workspace to relay data from the third party workspace to the compute agnostic project workspace 302.

In some embodiments, the first party computing resource 304 receives, via the first party routine set 324, a publication request. The publication request may be initiated and/or received from the compute agnostic project workspace 302 (e.g., a sub-workspace thereof). In addition, or alternatively, the publication request may be initiated and/or received from a third party workspace of a third party computing resource. The publication request may include a request generated in response to a call to a publication request routine of the first party routine set 324.

In response to the publication request, the first party computing resource 304 may generate evaluation data for at least an aspect of a machine learning project within a third party workspace by initiating the performance of one or more project quality routines from the first party routine set 324 within the third party workspace.

In some embodiments, project quality routines are data entities that represent particular computing functionalities implemented by a first party routine set 324. The project quality routines may include one or more verification functions for verifying one or more aspects of a machine learning project. By way of example, the project quality routines may include one or more scanning functions for verifying the completeness of a project, one or more compiling functions for verifying the executability of the project, one or more data evaluation functions for verifying the data quality for a project, one or more model evaluation functions for verifying the model performance for a project, and/or the like. In some examples, the project quality routines may be included within a first party routine set 324 installed within a third party workspace to allow a first party computing resource 304 to check project quality at the third party workspace. By way of example, a call to a publication request routine may initiate the performance of the project quality routines within a third party workspace to generate evaluation data for the machine learning project. In some examples, the publication request routine may be configured to relay data from the third party workspace based on the evaluation data.

In some embodiments, evaluation data is a data entity that represents one or more evaluated aspects of a machine learning project. The evaluation data may include a plurality of project quality metrics generated by the project quality routines. The project quality metrics may include one or more data quality metrics, such as data fairness, completeness, and/or the like, one or more model quality metrics, such as model fairness, overall performance, and/or the like, and/or any other metrics for evaluating a machine learning project.

In some embodiments, in response to publication request, the first party computing resource 304 modifies the compute agnostic project workspace 302 based on a comparison between evaluation data for an aspect of a machine learning project and one or more publication criteria.

In some embodiments, the compute agnostic project workspace 302 is modified by pulling data from a third party workspace to populate a sub-workspace of the compute agnostic project workspace 302. For example, in response to a publication request initiated from the first sub-workspace and/or a corresponding first third party workspace 316, the first party computing resource 304 may cause the first third party workspace 316 to generate evaluation data. In the event that the evaluation data satisfies publication criteria for publishing data from the first third party workspace 316 to the compute agnostic project workspace 302, the first party computing resource 304 may receive, retrieve, and/or otherwise accept project data from the first third party workspace 316. The project data may include a state of at least one aspect of the machine learning project that may be reflective of one or more characteristics for a particular stage of the machine learning project.

In addition, or alternatively, in some embodiments, the compute agnostic project workspace 302 is modified by generating and/or modifying a canonical representation 328 of the machine learning project. For example, in response to determining that the machine learning project satisfies publication criteria for publishing data from a respective third party workspace to a canonical representation 328 of the machine learning project, the first party computing resource 304 may generate the canonical representation 328 of the machine learning project that represents one or more model attributes for the machine learning project. The one or more model attributes, for example, may include one or more model quality metrics for the machine learning project.

In some embodiments, the canonical representation 328 is a data entity that represents a standardized representation of a machine learning project. The canonical representation 328 may include a plurality of model characteristics that describe one or more aspects of the development and/or performance of a machine learning model orchestrated using the first party computing resource 304 (e.g., a compute agnostic project workspace 302 thereof). For example, the canonical representation 328 may include configuration data, evaluation data, and/or the like, for a machine learning model developed, maintained, and/or at least partially hosted within the compute agnostic project workspace 302. In some examples, the canonical representation 328 may include interface points 332 (e.g., interactive links, pointer, API endpoints, etc.) for accessing the machine learning model and/or a workspace for a portion of the machine learning model (e.g., hosted by a first and/or third party computing resource, etc.).

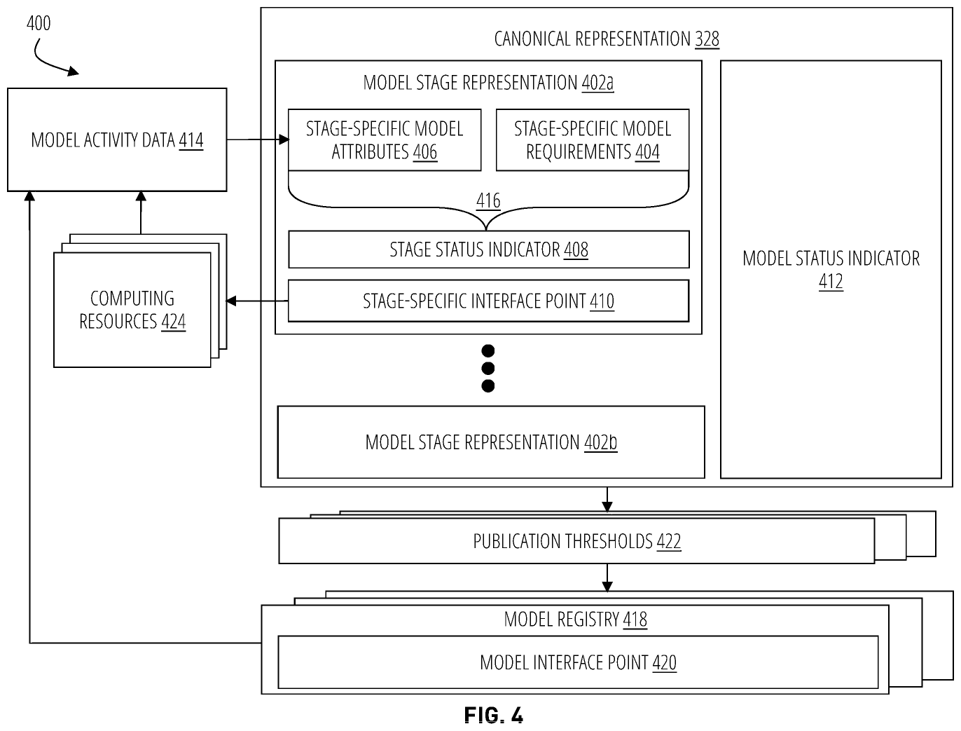

As described herein, the first party computing resource 304 may generate a compute agnostic project workspace 302 that facilitates the configuration, development, refinement, review, and deployment of a machine learning project across a plurality of distinct, incompatible, third party computing resources. The compute agnostic project workspace 302 may be leveraged to generate a canonical representation 328 of a machine learning model that may be used in a monitoring process for tracking and controlling each stage of a machine learning model's lifecycle. An example of the monitoring process will now further be described with reference to FIG. 4.

FIG. 4 is a dataflow diagram 400 showing example data structures for facilitating a canonical model tracking process in accordance with some embodiments discussed herein. The dataflow diagram 400 depicts a set of data structures and computing entities for generating a canonical representation 328 for providing standardized control and transparency for various machine learning models implemented across a plurality of disparate computing resources.

The canonical representation 328 may be generated, by a first party computing resource, for a machine learning model associated with a compute agnostic project workspace that is communicatively connected to a plurality of third party workspaces hosted by one or more of a plurality of different third party computing resources. In some examples, the canonical representation 328 may include one or more model stage representations, such as the model stage representations 402a-b. Each of the model stage representations 402a-b may be indicative of one or more model stages for the machine learning model. Taking the model stage representation 402a as an example, the model stage representation 402a may be indicative of a plurality of stage-specific model criteria (e.g., stage-specific model attributes 406, stage-specific model requirements 404, etc.) associated with a model stage that corresponds to the model stage representation 402a and a stage-specific interface point 410 for accessing one or more first or third party workspaces associated with the model stage. A stage-specific interface point 410, for example, may include a first party stage-specific interface point for accessing one or more first party workspaces (and/or sub-workspaces thereof) associated with the model stage. In addition, or alternatively, the stage-specific interface point 410 may include a third party stage-specific interface point for accessing one or more third party workspaces (and/or sub-workspaces thereof) associated with the model stage.

In some embodiments, the model stage representations 402a-b are indicative of one or more model stages of a machine learning model lifecycle. The model stages may be defined by a first party entity associated with the first party computing resource. In some examples, the model stages apply to each machine learning model across each machine learning project orchestrated by the first party computing resource.

In some embodiments, a model stage representation 402a includes a plurality of stage-specific model criteria for a respective model stage of the model lifecycle. The stage-specific model criteria may include one or more stage-specific model attributes 406 and/or one or more stage-specific model requirements 404 that correspond to the respective model stage. The stage-specific model attributes 406, for example, may include one or more characteristics, such as data attributes, performance attributes, training attributes, model parameter attributes, and/or the like, that correspond to the respective model stage. The stage-specific model requirements 404 may include one or more defined standards for completing the respective model stage. The one or more model requirements, for example, may be defined by a first party entity to standardize model development and enforce model standards across a plurality of different machine learning projects orchestrated by the first party computing resource.

In some embodiments, a model stage representation includes of a stage status indicator 408 for a respective model stage. The stage status indicator 408 may be indicative of a proportion 416 of the one or more stage-specific model requirements 404 that are satisfied by a machine learning model. The proportion 416 of the stage-specific model requirements 404, for example, may be based on the stage-specific model attributes 406.

In some embodiments, a model stage representation 402a includes one or more stage-specific interface points 410. A stage-specific interface point 410, for example, may include one or more first and/or third party interface points for accessing a workspace and/or sub-workspace associated with a respective model stage of a machine learning model. For example, a stage-specific interface point 410 (e.g., interactive links, pointer, API endpoints, etc.) may include a third party stage-specific interface point for accessing one or more third party workspaces associated with a respective model stage. In addition, or alternatively, a stage-specific interface point (e.g., interactive links, pointer, API endpoints, etc.) may include a first party stage-specific interface point for accessing a sub-workspace of a compute agnostic project workspace associated with a respective model stage.

In some embodiments, a model lifecycle is a data entity that describes an end-to-end machine learning model development and deployment process. A model lifecycle may include a plurality of model stages that define one or more distinct portions of a machine learning model development and/or deployment process. A model lifecycle may be model agnostic and may be applied to any type of machine learning model. In some examples, the model may be defined at an enterprise level, such as by a first party entity, to track each of a plurality of machine learning models as each model independently transitions between model stages during the development and subsequent deployment and usage of the machine learning model.

In some embodiments, a model stage is a data entity that describes a portion of a model lifecycle. A model stage may include a distinct segment of a machine learning model lifecycle that defines one or more actions, attributes, parameters, requirements, and/or the like for a machine learning model at a particular stage of the model's development, deployment, and/or subsequent usage. By way of example, a model stage may correspond to one or more configuration, training, evaluation, and preliminary testing stages of a model's lifecycle before the model is trained and deployed. As another example, a model stage may correspond to post-deployment evaluation, validation, and/or tracking stages of a model's lifecycle subsequent to the development and initial training of the model. A model stage may be defined at an enterprise level, such as by a first party entity, and may depend on the prediction domain and/or goals of the enterprise. Each stage, for example, may be directed to a particular task, operation, and/or goal of an enterprise and may be defined to derive holistic insights for the enterprise across a variety of machine learning models governed by the enterprise.

In some embodiments, the one or more model stages may include a model configuration stage, a model data preparation stage, a model experiment stage, a model review stage, and/or a model deployment stage. The model stage representation 404a, for example, may correspond to a model configuration stage, a model data preparation stage, a model experiment stage, a model review stage, and/or a model deployment stage. During a model configuration stage, a machine learning model architecture may be identified, accessed, generated, modified, tested, validated, and/or the like. During a model data preparation stages, training data for the model may be identified, accessed, generated, modified, tested, validated, and/or the like. During a model experiment stage, the model may be trained, tested, validated, modified, and/or the like using the training data. During a model review stage, the model may be tested, evaluated, validated, and/or the like with respect to one or more deployment publication criteria. During a model deployment stage, the model may be deployed for use to one or more users.

In some embodiments, the stage-specific model attributes 406 are indicative of one or more of a plurality of model attributes for the machine learning model that are associated with a particular model stage. For example, a model attribute may be a data entity that describes a characteristic of a machine learning model. A model attribute may include any characteristic associated with a machine learning model at any stage of the model's lifecycle.

For instance, a model attribute may include a model configuration attribute, such a model architecture attribute (e.g., model type, number of branches, nodes, etc.), a model arrangement attribute for an ensemble model, a model version attribute, and/or the like. In some examples, a model configuration stage may be associated with one or model configuration attributes.

As another example, a model attribute may include a data attribute, such as a dataset attribute (e.g., a dataset name, dataset source, dataset characteristics, dataset metrics, etc.), a data filtering attribute (e.g., a filtering parameter for focusing on different types of data, etc.), a data size attribute, a data validation, testing, and training ratio attribute, a data quality attribute, and/or the like. In some examples, a model data preparation stage may be associated with one or more data attributes.

As another example, a model attribute may include an experiment attribute, such as a training type attribute (e.g., a loss function, optimization function, etc.), a performance attribute (e.g., AUCROC, F1, precision, accuracy, recall, etc.), and/or the like. In some examples, a model experiment stage may be associated with one or more experiment attributes.

As another example, a model attribute may include an evaluation attribute, such as a fairness attribute (e.g., a relative performance with respect to different training objects, etc.), a reliability attribute (e.g., a consistency of performance, etc.), an interpretability attribute, a robustness attribute, and/or the like. In some examples, a model review stage may be associated with one or more evaluation attributes.

As another example, a model attribute may include a usage attribute, such as an accessed attribute (e.g., a number of calls to a deployed model, etc.), an expense attribute (e.g., a processing and storage expenditure for deploying the model, etc.), a return attribute, and/or the like. In some examples, a model deployment stage may be associated with one or more usage attributes.

In some embodiments, the stage-specific model requirements 404 are indicative of one or more of a plurality of model requirements for the machine learning model that are associated with a particular model stage. For example, a model requirement may be a data entity that describes a requirement for a machine learning model. A model requirement may include any standard for evaluating the completeness and/or performance of a machine learning model. A model requirement may include a threshold metric, required model attribute, and/or the like that may be defined at an enterprise level (e.g., by a first party entity) to ensure compliance across a plurality of different machine learning models governed by an enterprise. In some examples, the stage-specific model requirements 404 may form a stage lifecycle for a model stage. For instance, a model requirement may be indicative of a requirement for completing a respective model stage. In some examples, a machine learning model may be restricted from transitioning to a subsequent model stage until each of the model requirements are satisfied for a previous model stage. In some examples, a machine learning model may be transitioned back to a previous model stage in the event that one or more of the model requirements are no longer satisfied for a current model stage.

As examples, the model requirements for a model configuration stage may include one or more configuration requirements indicative of one or more approved model architectures, sources, sizes, versions, arrangements, and/or the like. In addition, or alternatively, the configuration requirements may require verified access to a model configuration (e.g., a model configuration from a third party data source, etc.), a verified upload of a model configuration, a verified compilation of the model configuration, and/or the like.

As another example, one or more model requirements for a model data preparation stage may include one or more data requirements indicative of one or more approved datasets, data sources, sizes, versions, arrangements, and/or the like. In addition, or alternatively, the data requirements may be indicative of verified access to a dataset (e.g., a dataset from a third party data source, etc.), a verified upload of a dataset, and/or the like. In some examples, the data requirements may include one or more required data quality thresholds, such as one or more accuracy thresholds, completeness thresholds, consistency thresholds, freshness thresholds (e.g., within a particular time period, etc.), uniqueness thresholds, validity thresholds, and/or the like. In some examples, the data requirements may be indicative of one or more set validation, testing, and training thresholds (e.g., particular percentages of data, etc.).

As another example, one or more model requirements for a model experiment stage may include one or more experiment requirements indicative of one or more model performance thresholds, such as one or more AUCROC thresholds, F1 thresholds, precision thresholds, accuracy thresholds, recall thresholds, and/or the like.

As another example, one or more model requirements for a model review stage may include one or more review requirements indicative of one or more fairness thresholds, reliability thresholds, interpretability thresholds, robustness thresholds, and/or the like.

As another example, one or more model requirements for a model deployment stage may include one or more usage requirements indicative of one or more access thresholds, expense thresholds, return thresholds, and/or the like.

In some embodiments, the canonical representation 328 includes a model status indicator 412 that describes a machine learning model's status relative to a model lifecycle. For instance, the model status indicator 412 may be indicative of a proportion of the one or more model requirements (e.g., for each of the model stages, etc.) that are satisfied by the machine learning model. In some examples, the model status indicator 412 is indicative of a proportion of the one or more model stages that are satisfied by the machine learning model. By way of example, the model status indicator 412 may be indicative of an aggregation of each of the stage status indicators 408 for each model stage representation 402a-b represented by the canonical representation 328.

In some embodiments, the canonical representation 328 is continuously modified in accordance with activity (e.g., developmental, usage, etc.) impacting the model. For instance, activity may include development activity, such as coding actions, testing actions, data augmentation actions, and/or the like that impact a machine learning model by modifying one or more developmental attributes of the model. As another example, activity may include post-deployment activity, such as usage actions, post-deployment validation and/or evaluation action, and/or the like, that may impact the machine learning model by modifying one or more performance and/or usage attributes of the model.

In some embodiments, model activity data 414 is generated that records activity impacting a machine learning model. The model activity data 414, for example, may include development data received from computing resources 424 (e.g., first and/or third party computing resources, etc.) that host one or more workspaces within which at least a portion of the machine learning model (e.g., training data, etc.) may be developed, maintained, and/or evaluated. In addition, or alternatively, the model activity data 414 may include usage data received from one or more model registries 418 that provide access to a deployed machine learning model through a model interface point 420.

In some embodiments, the model activity data 414 is a data entity that describes development and/or usage data for a machine learning model. The model activity data 414, for example, may include metadata sourced from a model registry 418 and/or one or more first and/or third party computing resources 424.

For instance, the model activity data 414 may include model development data from one or more first and/or third party computing resources 424. The model development data may be indicative of activity within a first and/or third party workspace that may modify, augment, and/or remove one or more components of a machine learning model. The model development data may be indicative of one or more new, modified, and/or removed model attributes for a machine learning model. By way of example, model development data may record a computing action for configurating a training dataset for the machine learning model within a third party workspace. In such a case, the model development data may be indicative of a new data attribute for a machine learning model. The same examples may apply for any model stage of a model lifecycle.

In addition, or alternatively, the model activity data 414 may include usage data from a model registry 418. The usage data may be indicative of activity within a local and/or centralized registry that impacts a machine learning model by, for example, executing the model, storing the model, maintaining the model, validating the model, and/or the like. The usage data may be indicative of one or more new, modified, and/or removed model attributes for a machine learning model. By way of example, usage data may record a computing action for executing the machine learning model in response to an interaction with a model interface point within a model registry. In such a case, the usage data may be indicative of a modified usage attribute indicative of an incremented number of uses of the machine learning model.

In some embodiments, the canonical representation 328 is modified in response to model activity data 414. For instance, the canonical representation 328 may be automatically modified in response to the model activity data 414 to provide real time representation of a machine learning model. For example, in response to user activity within a third party and/or first party workspace of a plurality of first party and/or third party workspaces, model activity data may be received from a first party and third party computing resource associated with the first party and/or third party workspaces. The model activity data may be indicative of one or more modified model attributes that correspond to a respective model stage. The stage-specific model attributes 406 may be modified to reflect the modified model attributes. In some embodiments, the stage-specific model attributes 406 may be modified in real time.

In some embodiments, relative progress data may be generated for the machine learning model based on the model activity data 414. The relative progress data may be indicative of a relative development progress of the machine learning model relative to a model stage of the one or more model stages. The relative progress data for the machine learning model, for example, may be indicative of an updated proportion of the one or more model requirements that are satisfied by the machine learning model based on the one or more modified model attributes. In some embodiments, the relative progress data may be reflected by an update stage status indicator and/or model status indicator.

For example, the canonical representation 328 of the machine learning model may be modified based on the model activity data 414 and/or the relative progress data. For instance, the model stage representation 402a may be augmented with the one or more modified model attributes. In addition, or alternatively, the stage status indicator 408 may be modified based on the updated proportion.

In some embodiments, the canonical representation 328 is leveraged to automatically publish a machine learning model to a model registry 418. The machine learning model, for example, may be published based on the model status indicator 412, one or more stage status indicators 408, and/or the one or more stage-specific model requirements 404 satisfied by the machine learning model. In some examples, the machine learning model may be published based on a comparison between the canonical representation 328 and one or more publication thresholds 422. By way of example, in response to the canonical representation 328 satisfying a publication threshold 422, a model interface point 420 may be generated for accessing the machine learning model. Publishing a machine learning model may include providing the model interface point 420 for the machine learning model to one or more users through a model registry 418.

In some embodiments, the model interface point 420 is a construct that provides access to a machine learning model. A model interface point 420, for example, may include one or more interactive links, one or more pointers, and/or the like that connect a repository to one or more data sources for executing a machine learning model. In some examples, the model interface point 420 may include an application programming interface (API) endpoint. For instance, the model interface point 420 may include an API endpoint that may be called from the model registry 418.

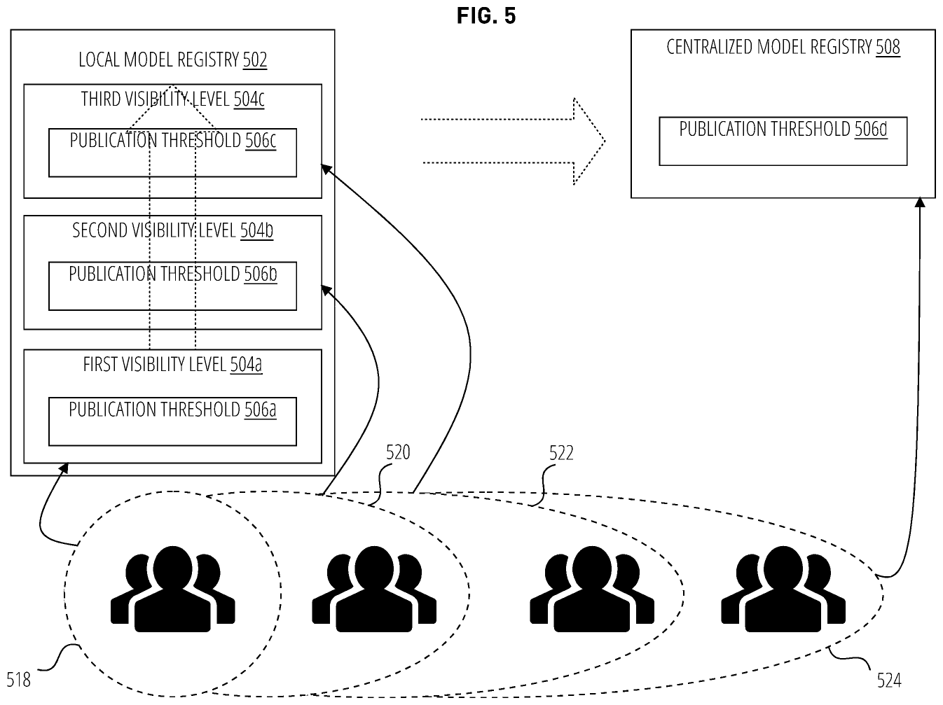

In some embodiments, access to machine learning model is restricted based on one or more publication thresholds 422 satisfied by the canonical representation 328 of the model. For example, a publication threshold 422 may be a data entity that represents one or more first party requirements for providing access to a machine learning model from a particular model registry 418. A publication threshold 422 may be indicative of one or more model requirements, model status indicators 412, stage status indicators 408, and/or the like. A publication threshold 422, for example, may be tailored to a model registry 418 and/or the one or more model requirements. In this manner, access to a machine learning model may be provided to different users based on the stage of development of the model. For example, a machine learning model may be published to one or more of a plurality of model registries 418. Each model registry 418 may be associated with a respective set of users (and/or user privilege levels) and/or publication criteria for allowing access of the machine learning model to the respective set of users. An example model registry ecosystem will now further be described with reference to FIG. 5.

FIG. 5 is an operational example of model registry ecosystem 500 in accordance with some embodiments discussed herein. The model registry ecosystem 500 may include a plurality of hierarchical registries, each tailored to a particular group of users, privilege levels of the users, and the model requirements satisfied by a plurality of machine learning models.

A model registry is a data structure for providing access to one or more machine learning models. For instance, the model registry may include one or more database(s), for example local database(s), cloud database(s), and/or any combination thereof. The model registry may be specially configured to store any number of data object(s), each embodying a stored machine learning model. In some embodiments, for example, a respective model registry may be specially configured to store a canonical representation for each machine learning model that successfully completes a publication to the respective model registry. By way of example, a respective model registry may include a plurality of model interface points for a plurality of models published to the model registry.

In some embodiments, a model registry includes a local model registry 502 that is associated with a plurality of visibility levels and/or a centralized model registry 512.

In some embodiments, the local model registry 502 is a model registry for providing access to one or more machine learning models in a localized, developmental computing environment. In some embodiments, a local model registry 502 may be sectioned into one or more different development environments with one or more different visibility levels 504a-c. Each visibility level may require one or more user permissions for accessing the local model registry 502. A visibility level, for example, may include a portion of the local model registry 502. For instance, the local model registry 502 may be divided into a plurality of visibility levels 504a-c. Each visibility level may be associated with one or more different publication thresholds for allow access to a user with a particular level of user permissions.

For example, a first publication threshold 506a for a first visibility level 504a of a local model registry 502 may be indicative of one or more model requirements for a first model stage of a model lifecycle. As another example, a second publication threshold 506b for a second visibility level 504b of a local model registry 502 may be indicative of one or more model requirements for a second model stage of a model lifecycle. As another example, a third publication threshold 506c for a third visibility level 504c of a local model registry 502 may be indicative of one or more model requirements for a third model stage of a model lifecycle.

In some embodiments, the centralized model registry 508 is a model registry for providing access to one or more machine learning models in a global, deployment computing environment. In some embodiments, a centralized registry may be associated with a deployment publication threshold 506d that is higher than the development publication thresholds 506a-c of the local model registry 502. The deployment publication threshold 506d, for example, may be indicative of one or more model requirements for each model stage of a model lifecycle.

Each of the publication threshold 506a-d may be indicative of different standards for a machine learning model. In some examples, the publication thresholds 506a-d may be based on a visibility of a visibility level of the local model registry 502 and/or the centralized model registry 508. By way of example, a standard defined by a publication threshold may increase with the visibility of a visibility level of the local model registry 502 and/or the centralized model registry 508. A visibility of a particular registry, for example, may be indicative of a number and/or type of users with access to a particular registry.

For example, each of the registries may be associated with one or more of a plurality of users 528. For instance, the centralized model registry 508 may provide global access to one or more machine learning models to each of the plurality of users 532. Due to the global visibility of the centralized model registry 508, the deployment publication threshold 506d may define the highest standard for a machine learning model.

In some examples, the local model registry 502 may include varying levels of access to a first subset 522 of the plurality of users 524. For example, the first subset 522 of the plurality of users 524 may have access to one or more machine learning models at a third visibility level 504c of the local model registry 502. As another example, a second subset 520 of the plurality of users 524 may have access to one or more machine learning models at a second visibility level 504b of the local model registry 502. As yet another example, a third subset 518 of the plurality of users 524 may have access to one or more machine learning models at a third visibility level 504c of the local model registry 502. Due to the increasing visibility at each visibility level of the local model registry 502, the development publication thresholds 506a-c may define a highest standard at each incremental visibility level.

In some embodiments, a model interface point for a machine learning model is transitioned between visibility levels of the local model registry 502 and centralized model registry 508 based on one or more publication thresholds satisfied by a canonical representation of the machine learning model. For example, a model interface point may be added and/or removed from a visibility level of the local model registry 502 and/or centralized model registry 508 based on model actively data and/or any other impacts to the model requirements satisfied by a machine learning model.

By way of example, as described herein, a canonical representation of the machine learning model may be modified to reflect an increase relative progress for the machine learning model in response to development activity within an associated workspace. In such a case, the machine learning model may satisfy one or more new publication thresholds and, as a result, a model interface point may be added to a visibility level of a local model registry 502 and/or the centralized model registry 508 that corresponds to the new publication thresholds.

In addition, or alternatively, a canonical representation of the machine learning model may be modified to reflect a decreased relative progress for the machine learning model in response to usage activity from a registry. For example, the canonical representation may include a model stage representation corresponding to a model deployment stage of the machine learning model. The model deployment stage may be associated with one or more stage-specific model attributes that are indicative of a model usage. In some examples, an access request may be received for the machine learning model using a model interface point within a model registry. Usage data may be generated based on the access request and the model stage representation corresponding to a model deployment stage may be modified based on the usage data. In some examples, the deployment stage may be associated with one or more stage-specific model requirements that are indicative of a model usage threshold. One or more model usage metrics may be generated for the machine learning model based on the usage data. In some examples, the model interface point for the machine learning model may be removed from the model registry based on the one or more usage metrics. By way of example, the model interface point may be removed based on a lower usage rate, a high computing cost, a return that fails to meet a return threshold, and/or the like.

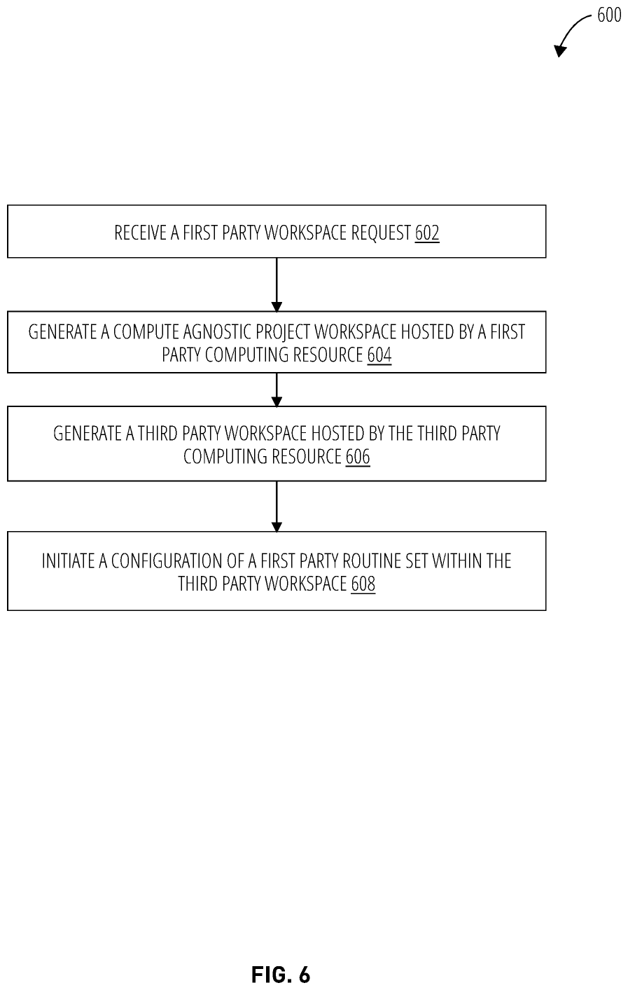

FIG. 6 is a flowchart showing an example of a process 600 for generating a compute agnostic project workspace in accordance with some embodiments discussed herein. The flowchart depicts new compute agnostic project workspace configuration and management techniques for generating a compute agnostic project workspace that overcome various limitations of traditional project workspaces that are limited to the local functionalities provided by their respective computing resources. The workspace configuration and management techniques may be implemented by one or more computing devices, entities, and/or systems described herein. For example, via the various steps/operations of the process 700, the computing system 100 may leverage the workspace configuration and management techniques to overcome the various limitations with traditional project workspaces by facilitating a compute agnostic project workspace capable of seamlessly leveraging compute functionalities across a plurality of different computing resources from one central location.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, receiving a first party workspace request. For example, the computing system 100 may receive the first party workspace request. In some examples, the first party workspace request may be indicative of a third party computing resource. In some examples, the first party workspace request may be indicative of a plurality of third party computing resources. In some embodiments, the first party workspace request includes selection input.

In some examples, the computing system 100 may provide a first selection interface for display. The first selection interface may include one or more interactive data selection widgets indicative of a first plurality of third party computing resources for data configuration. The computing system 100 may receive a first selection input from the first selection interface hosted by the first party computing resource. The first selection input may identify a first third party computing resource for configuring a training dataset for the machine learning model.

In some examples, the computing system 100 may provide a second selection interface for display. The second selection interface may include one or more interactive compute selection widgets indicative of a second plurality of third party computing resources for model configuration. The computing system 100 may receive a second selection input from a second selection interface hosted by the first party computing resource. The second selection input may identify a second third party computing resource for configuring a training dataset for the machine learning model.

In some examples, the first third party computing resource and the second third party computing resource may be different third party computing resources.

In some embodiments, the process 600 includes, at step/operation 604, generating a compute agnostic project workspace hosted by a first party computing resource. For example, the computing system 100 may generate the compute agnostic project workspace hosted by the first party computing resource. In some examples, the computing system 100 may generate the compute agnostic project workspace in response to the first party workspace request.

In some embodiments, the compute agnostic project workspace includes a plurality of sub-workspaces for the machine learning project. Each sub-workspace may be associated with one of a plurality of stages of development for the machine learning project. In some examples, the plurality of stages of development may include a data preparation stage, a model experiment stage, a model review stage, and/or a model deployment stage.

In some embodiments, the process 600 includes, at step/operation 606, initiating the generation of a third party workspace hosted by a third party computing resource. For example, the computing system 100 may initiate the generation of the third party workspace hosted by the third party computing resource. In some examples, the computing system 100 may initiate the generation of the third party workspace in response to the first party workspace request. The computing system 100 may initiate the generation of a respective third party workspace for each of the plurality of third party computing resources identified by the first party workspace request.

In some examples, the first party workspace request may be associated with one or more user subscriptions. The one or more user subscriptions may be indicative of one or more resource permissions for the third party computing resource. For example, the one or more resource permissions may be indicative of at least one of an amount of allocated space for a user and/or an amount of allocated compute power for the user. The third party workspace may be generated using the one or more user subscriptions.

In some embodiments, the process 600 includes, at step/operation 608, initiating the configuration of a first party routine set within the third party workspace. For example, the computing system 100 may initiate the configuration of the first party routine set within the third party workspace. In some examples, the computing system 100 may initiate the configuration of the first party routine set within the third party workspace in response to the first party workspace request. The first party routine set may include a plurality of webhooks for facilitating communication between the first party computing resource and the third party computing resource. The computing system 100 may initiate the configuration of the first party routine set within the respective third party workspace for each of the plurality of third party computing resources to facilitate communication between the first party computing resource and each of the plurality of third party computing resources.

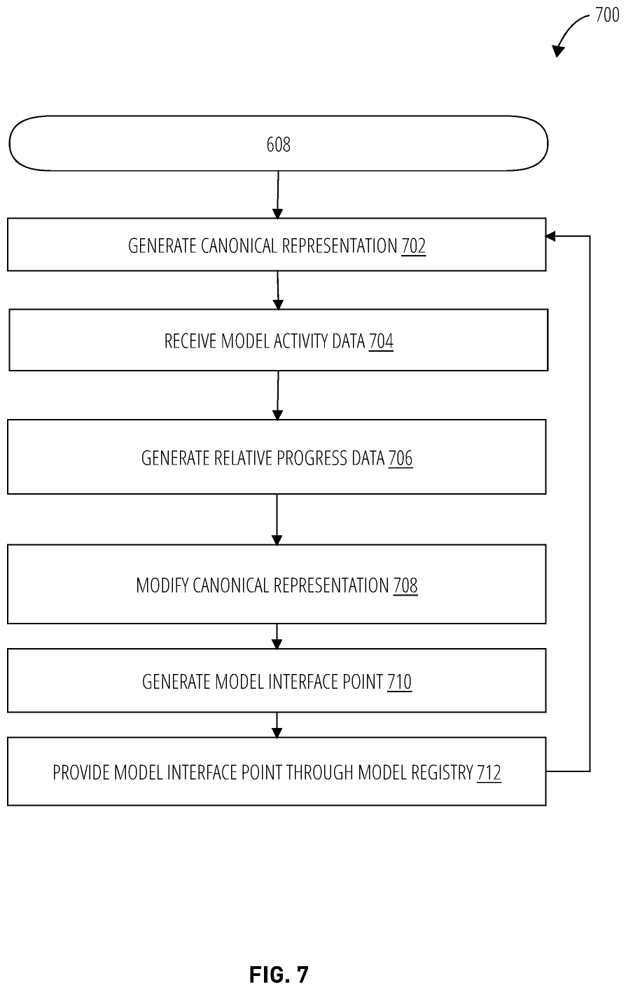

FIG. 7 is a flowchart showing an example of a process 700 for tracking and controlling access to a machine learning model in accordance with some embodiments discussed herein. The flowchart depicts new canonical representations for machine learning models that allow for improved monitoring techniques for tracking and controlling access to a machine learning model that overcome various limitations of traditional project workspaces. The monitoring techniques may be implemented by one or more computing devices, entities, and/or systems described herein. For example, via the various steps/operations of the process 700, the computing system 100 may leverage the monitoring techniques to overcome the various limitations with traditional project workspaces by atomically tracking model activity across a plurality of disparate computing resources and selectively publishing (and/or revoking publication) of machine learning models based on universal and model agnostic model criteria.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes a plurality of steps/operations subsequent to the step/operation 608 of process 600, where the process 600 includes initiating the configuration of a first party routine set within a third party workspace to facilitate communication between a compute agnostic project workspace and a third party workspace. In some examples, the compute agnostic project workspace generated in accordance with the steps/operations of process 600 may be leveraged to perform the process 700.

In some embodiments, the process 700 includes, at step/operation 702, generating a canonical representation. For example, the computing system 100 may generate a canonical representation of a machine learning model associated with a compute agnostic project workspace that is communicatively connected to a plurality of third party workspaces hosted by one or more of a plurality of different third party computing resources. In some examples, the canonical representation includes one or more model stage representations that are indicative of one or more model stages for the machine learning model. The one or more model stages, for example, may include a model configuration stage, a model data preparation stage, a model experiment stage, a model review stage, and/or a model deployment stage

Each model stage representation of the one or more model stage representations may be indicative of a plurality of stage-specific model criteria associated with a model stage of the one or more model stages that corresponds to the model stage representation and a stage-specific, third party interface point for accessing one or more third party workspaces associated with the model stage. In some examples, the plurality of stage-specific model criteria defines one or more stage-specific model attributes and/or one or more stage-specific model requirements. The model stage representation may include a stage status indicator that is indicative of a proportion of the one or more model requirements that are satisfied by the machine learning model. In some examples, the one or more stage-specific model attributes are indicative of one or more of a plurality of model attributes for the machine learning model that are associated with the model stage.

In some embodiments, the process 700 includes, at step/operation 704, receiving model activity data. For example, in response to user activity within a third party workspace of a plurality of third party workspaces, the computing system 100 may receive model activity data from a third party computing resource associated with the third party workspace. In some examples, the model activity data may be indicative of one or more modified model attributes that correspond to the model stage.

In some embodiments, the process 700 includes, at step/operation 706, generating relative progress data. For example, the computing system 100 may generate relative progress data for the machine learning model based on the model activity data. In some examples, the relative progress data may be indicative of a relative development progress of the machine learning model relative to a model stage of the one or more model stages. In some examples, the relative progress data for the machine learning model may be indicative of an updated proportion of the one or more model requirements that are satisfied by the machine learning model based on the one or more modified model attributes.

In some embodiments, the process 700 includes, at step/operation 708, modifying the canonical representation. For example, the computing system 100 may modify the canonical representation of the machine learning model based on the model activity data and the relative progress data. In some examples, the computing system 100 may augment the model stage representation with the one or more modified model attributes. In addition, or alternatively, the computing system 100 may modify the stage status indicator based on the updated proportion.

In some examples, the canonical representation may include a model stage representation corresponding to a model deployment stage of the machine learning model. The model deployment stage may be associated with one or more stage-specific model attributes that are indicative of a model usage. For example, the computing system 100 may receive, using a model interface point, an access request for the machine learning model. The computing system 100 may generate usage data based on the access request and, in some examples, the computing system 100 may modify the model stage representation corresponding to a model deployment stage based on the usage data.

In some embodiments, the process 700 includes, at step/operation 710, generating the model interface point. For example, in response to the canonical representation satisfying a publication threshold, the computing system 100 may generate a model interface point for accessing the machine learning model.

In some embodiments, the process 700 includes, at step/operation 712, providing the model interface point through a model registry. For example, the computing system 100 may provide the model interface point for the machine learning model to one or more users through the model registry. In some examples, the model registry may include a local model registry that is associated with a plurality of visibility levels and/or a centralized model registry. The one or more users may be based on a visibility level of the local model registry and/or the centralized model registry. In some examples, the publication threshold may be based on the visibility level of the local model registry and/or the centralized model registry.

In some examples, the model deployment stage discussed above may be associated with one or more stage-specific model requirements that are indicative of a model usage threshold. The process 700 may further include generating one or more model usage metrics for the machine learning model based on the usage data and, in some examples, removing the model interface point for the machine learning model from the model registry based on the one or more usage metrics.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising generating, by one or more processors of a first party computing resource, a canonical representation of a machine learning model associated with a compute agnostic project workspace that is communicatively connected to a plurality of third party workspaces hosted by one or more of a plurality of different third party computing resources; in response to user activity within a third party workspace of the plurality of third party workspaces, receiving, by the one or more processors, model activity data from a third party computing resource associated with the third party workspace; generating, by the one or more processors, relative progress data for the machine learning model based on the model activity data; modifying, by the one or more processors, the canonical representation of the machine learning model based on the model activity data and the relative progress data; in response to the canonical representation satisfying a publication threshold, generating, by the one or more processors, a model interface point for accessing the machine learning model; and providing, by the one or more processors, the model interface point for the machine learning model to one or more users through a model registry.

Example 2. The computer-implemented method of example 1, wherein the relative progress data is indicative of a relative development progress of the machine learning model relative to a model stage of one or more model stages.

Example 3. The computer-implemented method of any of the preceding examples, wherein the canonical representation comprises one or more model stage representations that are indicative of one or more model stages for the machine learning model, wherein a model stage representation of the one or more model stage representations is indicative of (i) a plurality of stage-specific model criteria associated with a model stage of the one or more model stages that corresponds to the model stage representation and (ii) a stage-specific, third party interface point for accessing one or more third party workspaces associated with the model stage.

Example 4. The computer-implemented method of example 3, wherein the one or more model stages comprises a model configuration stage, a model data preparation stage, a model experiment stage, a model review stage, and a model deployment stage.

Example 5. The computer-implemented method of examples 3 or 4, wherein the plurality of stage-specific model criteria defines one or more stage-specific model attributes and one or more stage-specific model requirements, and wherein the model stage representation comprises a stage status indicator that is indicative of a proportion of the one or more model requirements that are satisfied by the machine learning model.

Example 6. The computer-implemented method of example 5, wherein the one or more stage-specific model attributes are indicative of one or more of a plurality of model attributes for the machine learning model that are associated with the model stage.

Example 7. The computer-implemented method of examples 5 or 6, wherein (i) the model activity data is indicative of one or more modified model attributes that correspond to the model stage, and (ii) the relative progress data for the machine learning model is indicative of an updated proportion of the one or more model requirements that are satisfied by the machine learning model based on the one or more modified model attributes.

Example 8. The computer-implemented method of example 7, wherein modifying the canonical representation of the machine learning model based on the model activity data and the relative progress data comprises augmenting the model stage representation with the one or more modified model attributes; and modifying the stage status indicator based on the updated proportion.

Example 9. The computer-implemented method of any of the preceding examples, wherein the model registry comprises a local model registry that is associated with a plurality of visibility levels or a centralized model registry and the one or more users are based on a visibility level of the local model registry or the centralized model registry.

Example 10. The computer-implemented method of example 9, wherein the publication threshold is based on the visibility level of the local model registry or the centralized model registry.

Example 11. A computer-implemented method of any of the preceding examples, wherein the canonical representation comprises a model stage representation corresponding to a model deployment stage of the machine learning model, the model deployment stage is associated with one or more stage-specific model attributes that are indicative of a model usage, and the computer-implemented method further comprises receiving, using the model interface point, an access request for the machine learning model; generating usage data based on the access request; and modifying the model stage representation corresponding to the model deployment stage based on the usage data.

Example 12. A computer-implemented method of example 11, wherein the model deployment stage is associated with one or more stage-specific model requirements that are indicative of a model usage threshold and the computer-implemented method further comprises generating one or more model usage metrics for the machine learning model based on the usage data; and removing the model interface point for the machine learning model from the model registry based on the one or more model usage metrics.

Example 13. A computing system comprising memory and one or more processors communicatively coupled to the memory, the one or more processors configured to generate a canonical representation of a machine learning model associated with a compute agnostic project workspace that is communicatively connected to a plurality of third party workspaces hosted by one or more of a plurality of different third party computing resources; in response to user activity within a third party workspace of the plurality of third party workspaces, receive model activity data from a third party computing resource associated with the third party workspace; generate relative progress data for the machine learning model based on the model activity data; modify the canonical representation of the machine learning model based on the model activity data and the relative progress data; in response to the canonical representation satisfying a publication threshold, generate a model interface point for accessing the machine learning model; and provide the model interface point for the machine learning model to one or more users through a model registry.

Example 14. The computing system of example 13, wherein the relative progress data is indicative of a relative development progress of the machine learning model relative to a model stage of one or more model stages.

Example 15. The computing system of examples 13 or 14, wherein the canonical representation comprises one or more model stage representations that are indicative of one or more model stages for the machine learning model, wherein a model stage representation of the one or more model stage representations is indicative of (i) a plurality of stage-specific model criteria associated with a model stage of the one or more model stages that corresponds to the model stage representation and (ii) a stage-specific, third party interface point for accessing one or more third party workspaces associated with the model stage.

Example 16. The computing system of example 15, wherein the one or more model stages comprises a model configuration stage, a model data preparation stage, a model experiment stage, a model review stage, and a model deployment stage.

Example 17. The computing system of example 16, wherein the plurality of stage-specific model criteria defines one or more stage-specific model attributes and one or more stage-specific model requirements, and wherein the model stage representation comprises a stage status indicator that is indicative of a proportion of the one or more model requirements that are satisfied by the machine learning model.

Example 18. The computing system of example 17, wherein the one or more stage-specific model attributes are indicative of one or more of a plurality of model attributes for the machine learning model that are associated with the model stage.

Example 19. One or more non-transitory computer-readable storage media including instructions that, when executed by one or more processors, cause the one or more processors to generate a canonical representation of a machine learning model associated with a compute agnostic project workspace that is communicatively connected to a plurality of third party workspaces hosted by one or more of a plurality of different third party computing resources; in response to user activity within a third party workspace of the plurality of third party workspaces, receive model activity data from a third party computing resource associated with the third party workspace; generate relative progress data for the machine learning model based on the model activity data; modify the canonical representation of the machine learning model based on the model activity data and the relative progress data; in response to the canonical representation satisfying a publication threshold, generate a model interface point for accessing the machine learning model; and provide the model interface point for the machine learning model to one or more users through a model registry.

Example 20. The one or more non-transitory computer-readable storage media of example 19, wherein the canonical representation comprises a model stage representation corresponding to a model deployment stage of the machine learning model, the model deployment stage is associated with one or more stage-specific model attributes that are indicative of a model usage, and the one or more processors further caused to receive, using the model interface point, an access request for the machine learning model; generate usage data based on the access request; and modify the model stage representation corresponding to the model deployment stage based on the usage data.

1. A computer-implemented method, the computer-implemented method comprising:
generating, by one or more processors of a first party computing resource, a canonical representation of a machine learning model associated with a compute agnostic project workspace that is communicatively connected to a plurality of third party workspaces hosted by one or more of a plurality of different third party computing resources;
in response to user activity within a third party workspace of the plurality of third party workspaces, receiving, by the one or more processors, model activity data from a third party computing resource associated with the third party workspace;
generating, by the one or more processors, relative progress data for the machine learning model based on the model activity data;
modifying, by the one or more processors, the canonical representation of the machine learning model based on the model activity data and the relative progress data;
in response to the canonical representation satisfying a publication threshold, generating, by the one or more processors, a model interface point for accessing the machine learning model; and
providing, by the one or more processors, the model interface point for the machine learning model to one or more users through a model registry.

2. The computer-implemented method of claim 1, wherein the relative progress data is indicative of a relative development progress of the machine learning model relative to a model stage of one or more model stages.

3. The computer-implemented method of claim 1, wherein the canonical representation comprises one or more model stage representations that are indicative of one or more model stages for the machine learning model, wherein a model stage representation of the one or more model stage representations is indicative of:
(i) a plurality of stage-specific model criteria associated with a model stage of the one or more model stages that corresponds to the model stage representation, and
(ii) a stage-specific, third party interface point for accessing one or more third party workspaces associated with the model stage.

4. The computer-implemented method of claim 3, wherein the one or more model stages comprises a model configuration stage, a model data preparation stage, a model experiment stage, a model review stage, and a model deployment stage.

5. The computer-implemented method of claim 3, wherein the plurality of stage-specific model criteria defines one or more stage-specific model attributes and one or more stage-specific model requirements, and wherein the model stage representation comprises a stage status indicator that is indicative of a proportion of the one or more model requirements that are satisfied by the machine learning model.

6. The computer-implemented method of claim 5, wherein the one or more stage-specific model attributes are indicative of one or more of a plurality of model attributes for the machine learning model that are associated with the model stage.

7. The computer-implemented method of claim 5, wherein:
(i) the model activity data is indicative of one or more modified model attributes that correspond to the model stage, and
(ii) the relative progress data for the machine learning model is indicative of an updated proportion of the one or more model requirements that are satisfied by the machine learning model based on the one or more modified model attributes.

8. The computer-implemented method of claim 7, wherein modifying the canonical representation of the machine learning model based on the model activity data and the relative progress data comprises:
augmenting the model stage representation with the one or more modified model attributes; and
modifying the stage status indicator based on the updated proportion.

9. The computer-implemented method of claim 1, wherein the model registry comprises a local model registry that is associated with a plurality of visibility levels or a centralized model registry and the one or more users are based on a visibility level of the local model registry or the centralized model registry.

10. The computer-implemented method of claim 9, wherein the publication threshold is based on the visibility level of the local model registry or the centralized model registry.

11. A computer-implemented method of claim 1, wherein the canonical representation comprises a model stage representation corresponding to a model deployment stage of the machine learning model, the model deployment stage is associated with one or more stage-specific model attributes that are indicative of a model usage, and the computer-implemented method further comprises:
receiving, using the model interface point, an access request for the machine learning model;
generating usage data based on the access request; and
modifying the model stage representation corresponding to the model deployment stage based on the usage data.

12. A computer-implemented method of claim 11, wherein the model deployment stage is associated with one or more stage-specific model requirements that are indicative of a model usage threshold and the computer-implemented method further comprises:
generating one or more model usage metrics for the machine learning model based on the usage data; and
removing the model interface point for the machine learning model from the model registry based on the one or more model usage metrics.

13. A computing system comprising memory and one or more processors communicatively coupled to the memory, the one or more processors configured to:
generate a canonical representation of a machine learning model associated with a compute agnostic project workspace that is communicatively connected to a plurality of third party workspaces hosted by one or more of a plurality of different third party computing resources;
in response to user activity within a third party workspace of the plurality of third party workspaces, receive model activity data from a third party computing resource associated with the third party workspace;
generate relative progress data for the machine learning model based on the model activity data;
modify the canonical representation of the machine learning model based on the model activity data and the relative progress data;
in response to the canonical representation satisfying a publication threshold, generate a model interface point for accessing the machine learning model; and
provide the model interface point for the machine learning model to one or more users through a model registry.

14. The computing system of claim 13, wherein the relative progress data is indicative of a relative development progress of the machine learning model relative to a model stage of one or more model stages.

15. The computing system of claim 13, wherein the canonical representation comprises one or more model stage representations that are indicative of one or more model stages for the machine learning model, wherein a model stage representation of the one or more model stage representations is indicative of:
(i) a plurality of stage-specific model criteria associated with a model stage of the one or more model stages that corresponds to the model stage representation, and
(ii) a stage-specific, third party interface point for accessing one or more third party workspaces associated with the model stage.

16. The computing system of claim 15, wherein the one or more model stages comprises a model configuration stage, a model data preparation stage, a model experiment stage, a model review stage, and a model deployment stage.

17. The computing system of claim 16, wherein the plurality of stage-specific model criteria defines one or more stage-specific model attributes and one or more stage-specific model requirements, and wherein the model stage representation comprises a stage status indicator that is indicative of a proportion of the one or more model requirements that are satisfied by the machine learning model.

18. The computing system of claim 17, wherein the one or more stage-specific model attributes are indicative of one or more of a plurality of model attributes for the machine learning model that are associated with the model stage.

19. One or more non-transitory computer-readable storage media including instructions that, when executed by one or more processors, cause the one or more processors to:
generate a canonical representation of a machine learning model associated with a compute agnostic project workspace that is communicatively connected to a plurality of third party workspaces hosted by one or more of a plurality of different third party computing resources;
in response to user activity within a third party workspace of the plurality of third party workspaces, receive model activity data from a third party computing resource associated with the third party workspace;
generate relative progress data for the machine learning model based on the model activity data;
modify the canonical representation of the machine learning model based on the model activity data and the relative progress data;
in response to the canonical representation satisfying a publication threshold, generate a model interface point for accessing the machine learning model; and
provide the model interface point for the machine learning model to one or more users through a model registry.

20. The one or more non-transitory computer-readable storage media of claim 19, wherein the canonical representation comprises a model stage representation corresponding to a model deployment stage of the machine learning model, the model deployment stage is associated with one or more stage-specific model attributes that are indicative of a model usage, and the one or more processors further caused to:
receive, using the model interface point, an access request for the machine learning model;
generate usage data based on the access request; and
modify the model stage representation corresponding to the model deployment stage based on the usage data.
